(19) United States
(12) Patent Application Publication
(10) Pub. No.: US 2026/0113461 A1
(43) Pub. Date: Apr. 23, 2026

(54) METHOD FOR IMPLICIT GEOMETRIC PARTITIONING MODE WITH INTRA AND INTER PREDICTION

(71) Applicant: Alibaba (China) Co., Ltd., Hangzhou (CN)

(72) Inventors: Ke JIA, Beijing (CN); Jie CHEN, Beijing (CN); Xinwei LI, Beijing (CN); Ru-ling LIAO, Sunnyvale, CA (US); Yan YE, San Diego, CA (US)

(21) Appl. No.: 19/334,168

(22) Filed: Sep. 19, 2025

Related U.S. Application Data
(60) Provisional application No. 63/708,744, filed on Oct. 17, 2024.

(51) Int. Cl. H04N 19/159; H04N 19/139; H04N 19/176; H04N 19/52

(52) U.S. Cl. CPC H04N 19/159; H04N 19/139; H04N 19/176; H04N 19/52

(57) ABSTRACT

The present disclosure provides a method of encoding a video sequence. The method includes: receiving a video sequence; encoding the video sequence by determining that an implicit geometric partitioning mode (GPM) is applied to a coding block, a coding block being split into two geometric partitions; and performing an intra and inter prediction on the coding block.

### CROSS-REFERENCE TO RELATED APPLICATIONS

This disclosure claims the benefits of priority to U.S. Provisional Application No. 63/708,744, filed on Oct. 17, 2024, which is incorporated herein by reference in its entirety.

### TECHNICAL FIELD

The present disclosure generally relates to video processing, and more particularly, to methods for implicit geometric partitioning mode (GPM) with intra and inter prediction.

### BACKGROUND

A video is a set of static pictures (or “frames”) capturing the visual information. To reduce the storage memory and the transmission bandwidth, a video can be compressed before storage or transmission and decompressed before display. The compression process is usually referred to as encoding and the decompression process is usually referred to as decoding. There are various video coding formats which use standardized video coding technologies, most commonly based on prediction, transformation, quantization, entropy coding and in-loop filtering. The video coding standards, such as the High Efficiency Video Coding (HEVC/H.265) standard, the Versatile Video Coding (VVC/H.266) standard, and AVS standards, specifying the specific video coding formats, are developed by standardization organizations. With more and more advanced video coding technologies being adopted in the video standards, the coding efficiency of the new video coding standards get higher and higher.

### SUMMARY OF THE DISCLOSURE

Embodiments of the present disclosure provide a method for encoding a video sequence. In some embodiments, the method includes receiving a video sequence; encoding the video sequence by: determining that an implicit geometric partitioning mode (GPM) is applied to a coding block, a coding block being split into two geometric partitions; and performing an intra and inter prediction on the coding block.

Embodiments of the present disclosure provide a method for decoding a bitstream. In some embodiments, the method includes receiving a bitstream; and decoding the bitstream to generate a video sequence, the decoding comprising: determining that an implicit geometric partitioning mode (GPM) is applied to a coding block, a coding block being split into two geometric partitions; and performing an intra and inter prediction on the coding block.

Embodiments of the present disclosure provide a method for signaling a bitstream. In some embodiments, the method includes receiving a video sequence; encoding the video sequence by determining that an implicit geometric partitioning mode (GPM) is applied to a coding block, a coding block being split into two geometric partitions; and performing an intra and inter prediction on the coding block; and signaling a bitstream that is generated based on the encoding.

### BRIEF DESCRIPTION OF THE DRAWINGS

Embodiments and various aspects of the present disclosure are illustrated in the following detailed description and the accompanying figures. Various features shown in the figures are not drawn to scale.

FIG. 1 is a schematic diagram illustrating structures of an exemplary video sequence, according to some embodiments of the present disclosure.

FIG. 2A is a schematic diagram illustrating an exemplary encoding process of a hybrid video coding system, consistent with embodiments of the disclosure.

FIG. 2B is a schematic diagram illustrating another exemplary encoding process of a hybrid video coding system, consistent with embodiments of the disclosure.

FIG. 3A is a schematic diagram illustrating an exemplary decoding process of a hybrid video coding system, consistent with embodiments of the disclosure.

FIG. 3B is a schematic diagram illustrating another exemplary decoding process of a hybrid video coding system, consistent with embodiments of the disclosure.

FIG. 4 is a block diagram of an exemplary apparatus for encoding or decoding a video, according to some embodiments of the present disclosure.

FIG. 5 illustrates examples of the geometric partition mode (GPM) splits grouped by identical angles, according to some embodiments of the present disclosure.

FIG. 6 illustrates an exemplary generation of a bending weight w₀ using geometric partitioning mode, according to some embodiments of the present disclosure.

FIG. 7 illustrates a ramp function for the weights for GPM blending based on the displacement (d) from a predicted sample position to the GPM partitioning boundary and the blending area size (t), according to some embodiments of the present disclosure.

FIG. 8 illustrates an exemplary edge on templates, according to some embodiments of the present disclosure.

FIGS. 9A-9C are schematic diagrams illustrating available IPM candidates for the GPM, according to some embodiments of the present disclosure.

FIG. 9D illustrates GPM with intra and intra prediction, according to some embodiments of the present disclosure.

FIG. 10 is a flow chart of an exemplary method for implicit GPM, according to some embodiments of the present disclosure.

FIG. 11 is a flowchart of an exemplary method for implicit GPM with intra and inter prediction, according to some embodiments of the present disclosure.

FIG. 12 is a flowchart of another exemplary method for implicit GPM with intra and inter prediction, according to some embodiments of the present disclosure.

FIG. 13 is a flowchart of an exemplary method for applying template matching (TM) to implicit GPM, according to some embodiments of the present disclosure.

FIG. 14A is a flowchart of another exemplary method for applying template matching (TM) to implicit GPM, according to some embodiments of the present disclosure.

FIG. 14B is a flowchart of sub-steps of method for applying TM implicit GPM as shown in FIG. 14A, according to some embodiments of the present disclosure

FIG. 15 is a flow chart of another exemplary method for applying template matching (TM) to implicit GPM, according to some embodiments of the present disclosure.

FIG. 16 is a flowchart of another exemplary method for applying template matching (TM) to implicit GPM, according to some embodiments of the present disclosure.

FIG. 17 is a flowchart of an exemplary method for applying merge motion vector differences (MMVD) to implicit GPM, according to some embodiments of the present disclosure

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims. Particular aspects of the present disclosure are described in greater detail below. The terms and definitions provided herein control, if in conflict with terms and/or definitions incorporated by reference.

The Joint Video Experts Team (JVET) of the ITU-T Video Coding Expert Group (ITU-T VCEG) and the ISO/IEC Moving Picture Expert Group (ISO/IEC MPEG) is currently developing the Versatile Video Coding (VVC/H.266) standard. The VVC standard is aimed at doubling the compression efficiency of its predecessor, the High Efficiency Video Coding (HEVC/H.265) standard. In other words, VVC's goal is to achieve the same subjective quality as HEVC/H.265 using half the bandwidth.

To achieve the same subjective quality as HEVC/H.265 using half the bandwidth, the JVET has been developing technologies beyond HEVC using the joint exploration model (JEM) reference software. As coding technologies were incorporated into the JEM, the JEM achieved substantially higher coding performance than HEVC.

The VVC standard has been developed recently and continues to include more coding technologies that provide better compression performance. VVC is based on the same hybrid video coding system that has been used in modern video compression standards such as HEVC, H.264/AVC, MPEG2, H.263, etc.

A video is a set of static pictures (or “frames”) arranged in a temporal sequence to store visual information. A video capture device (e.g., a camera) can be used to capture and store those pictures in a temporal sequence, and a video playback device (e.g., a television, a computer, a smartphone, a tablet computer, a video player, or any end-user terminal with a function of display) can be used to display such pictures in the temporal sequence. Also, in some applications, a video capturing device can transmit the captured video to the video playback device (e.g., a computer with a monitor) in real-time, such as for surveillance, conferencing, or live broadcasting.

For reducing the storage space and the transmission bandwidth needed by such applications, the video can be compressed before storage and transmission and decompressed before the display. The compression and decompression can be implemented by software executed by a processor (e.g., a processor of a generic computer) or specialized hardware. The module for compression is generally referred to as an “encoder,” and the module for decompression is generally referred to as a “decoder.” The encoder and decoder can be collectively referred to as a “codec.” The encoder and decoder can be implemented as any of a variety of suitable hardware, software, or a combination thereof. For example, the hardware implementation of the encoder and decoder can include circuitry, such as one or more microprocessors, digital signal processors (DSPs), application-specific integrated circuits (ASICs), field-programmable gate arrays (FPGAs), discrete logic, or any combinations thereof. The software implementation of the encoder and decoder can include program codes, computer-executable instructions, firmware, or any suitable computer-implemented algorithm or process fixed in a computer-readable medium. Video compression and decompression can be implemented by various algorithms or standards, such as MPEG-1, MPEG-2, MPEG-4, H.26x series, or the like. In some applications, the codec can decompress the video from a first coding standard and re-compress the decompressed video using a second coding standard, in which case the codec can be referred to as a “transcoder.”

The video encoding process can identify and keep useful information that can be used to reconstruct a picture and disregard unimportant information for the reconstruction. If the disregarded, unimportant information cannot be fully reconstructed, such an encoding process can be referred to as “lossy.” Otherwise, it can be referred to as “lossless.” Most encoding processes are lossy, which is a tradeoff to reduce the needed storage space and the transmission bandwidth.

The useful information of a picture being encoded (referred to as a “current picture”) include changes with respect to a reference picture (e.g., a picture previously encoded and reconstructed). Such changes can include position changes, luminosity changes, or color changes of the pixels, among which the position changes are most concerned. Position changes of a group of pixels that represent an object can reflect the motion of the object between the reference picture and the current picture.

A picture coded without referencing another picture (i.e., it is its own reference picture) is referred to as an “I-picture.” A picture is referred to as a “P-picture” if some or all blocks (e.g., blocks that generally refer to portions of the video picture) in the picture are predicted using intra prediction or inter prediction with one reference picture (e.g., uni-prediction). A picture is referred to as a “B-picture” if at least one block in it is predicted with two reference pictures (e.g., bi-prediction).

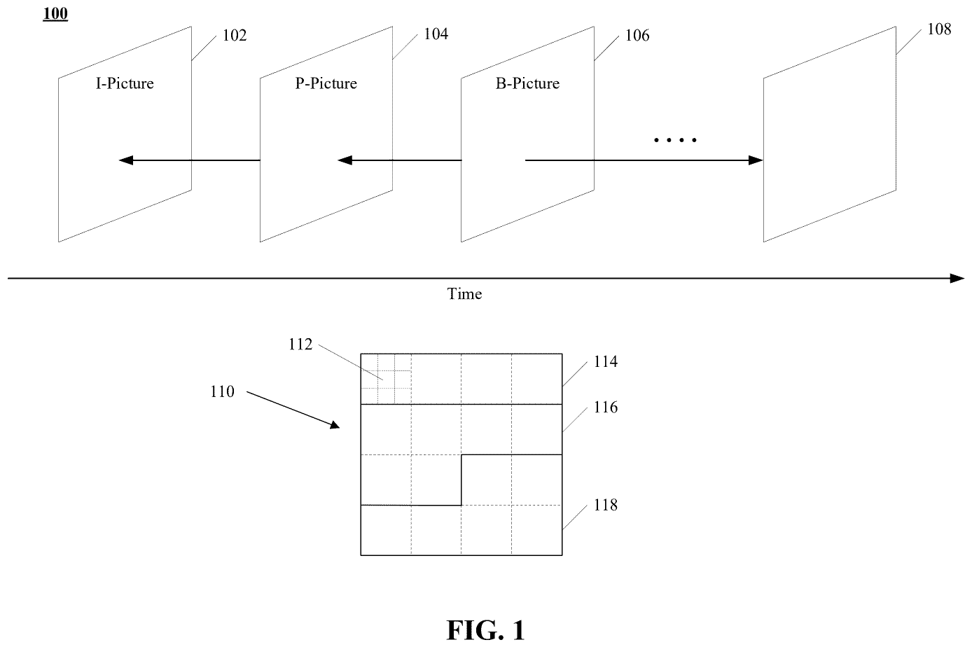

FIG. 1 illustrates structures of an exemplary video sequence 100, according to some embodiments of the present disclosure. Video sequence 100 can be a live video or a video having been captured and archived. Video sequence 100 can be a real-life video, a computer-generated video (e.g., computer game video), or a combination thereof (e.g., a real-life video with augmented-reality effects). Video sequence 100 can be inputted from a video capture device (e.g., a camera), a video archive (e.g., a video file stored in a storage device) containing previously captured video, or a video feed interface (e.g., a video broadcast transceiver) to receive video from a video content provider.

As shown in FIG. 1, video sequence 100 can include a series of pictures arranged temporally along a timeline, including pictures 102, 104, 106, and 108. Pictures 102-106 are continuous, and there are more pictures between pictures 106 and 108. In FIG. 1, picture 102 is an I-picture, the reference picture of which is picture 102 itself. Picture 104 is a P-picture, the reference picture of which is picture 102, as indicated by the arrow. Picture 106 is a B-picture, the reference pictures of which are pictures 104 and 108, as indicated by the arrows. In some embodiments, the reference picture of a picture (e.g., picture 104) cannot be immediately preceding or following the picture. For example, the reference picture of picture 104 can be a picture preceding picture 102. It should be noted that the reference pictures of pictures 102-106 are only examples, and the present disclosure does not limit embodiments of the reference pictures as the examples shown in FIG. 1.

Typically, video codecs do not encode or decode an entire picture at one time due to the computing complexity of such tasks. Rather, they can split the picture into basic segments and encode or decode the picture segment by segment. Such basic segments are referred to as basic processing units (“BPUs”) in the present disclosure. For example, structure 110 in FIG. 1 shows an example structure of a picture of video sequence 100 (e.g., any of pictures 102-108). In structure 110, a picture is divided into 4×4 basic processing units, the boundaries of which are shown as dash lines. In some embodiments, the basic processing units can be referred to as “macroblocks” in some video coding standards (e.g., MPEG family, H.261, H.263, or H.264/AVC), or as “coding tree units” (“CTUs”) in some other video coding standards (e.g., H.265/HEVC or H.266/VVC). The basic processing units can have variable sizes in a picture, such as 128×128, 64×64, 32×32, 16×16, 4×8, 16×32, or any arbitrary shape and size of pixels. The sizes and shapes of the basic processing units can be selected for a picture based on the balance of coding efficiency and levels of details to be kept in the basic processing unit.

The basic processing units can be logical units, which can include a group of different types of video data stored in a computer memory (e.g., in a video frame buffer). For example, a basic processing unit of a color picture can include a luma component (Y) representing achromatic brightness information, one or more chroma components (e.g., Cb and Cr) representing color information, and associated syntax elements, in which the luma and chroma components can have the same size of the basic processing unit. The luma and chroma components can be referred to as “coding tree blocks” (“CTBs”) in some video coding standards (e.g., H.265/HEVC or H.266/VVC). Any operation performed to a basic processing unit can be repeatedly performed to each of its luma and chroma components.

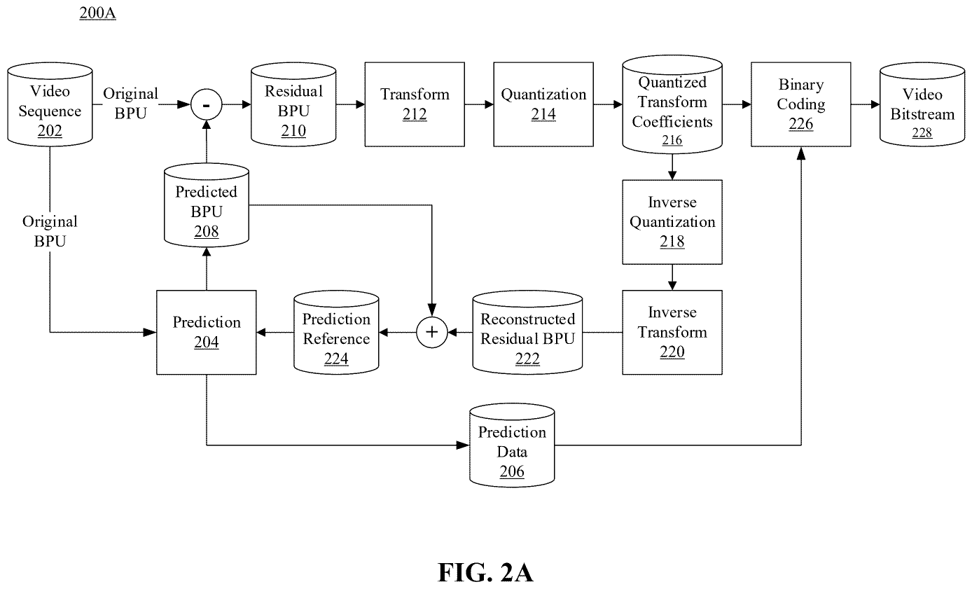

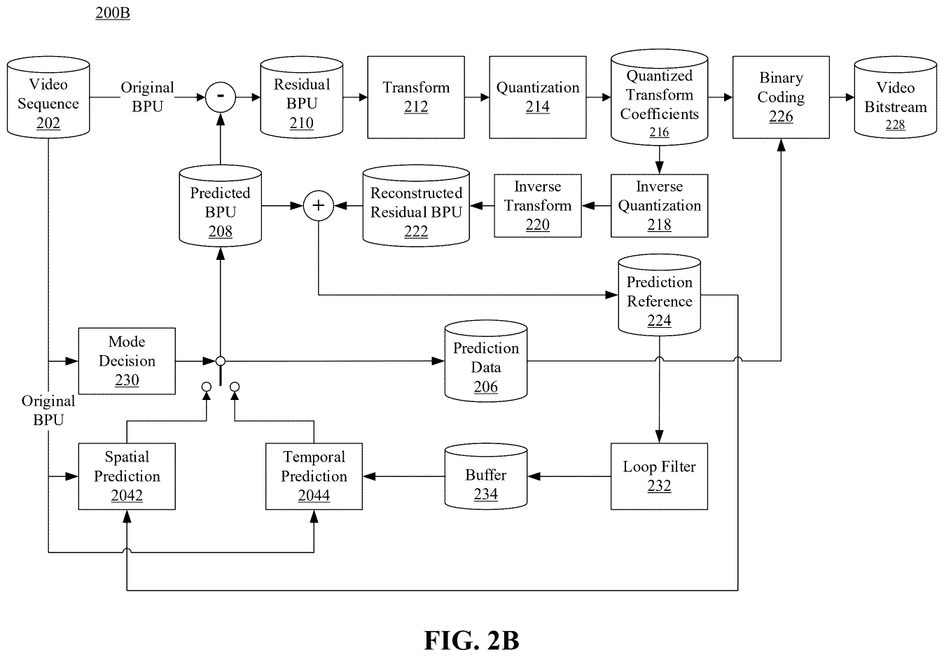

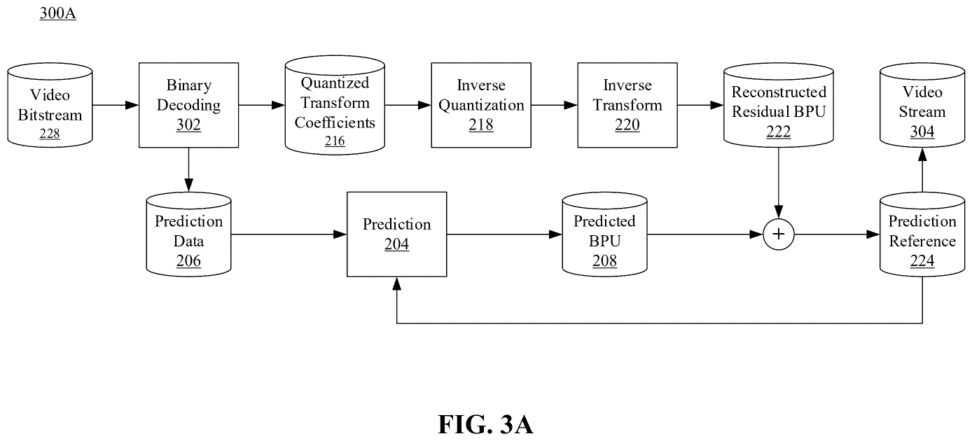

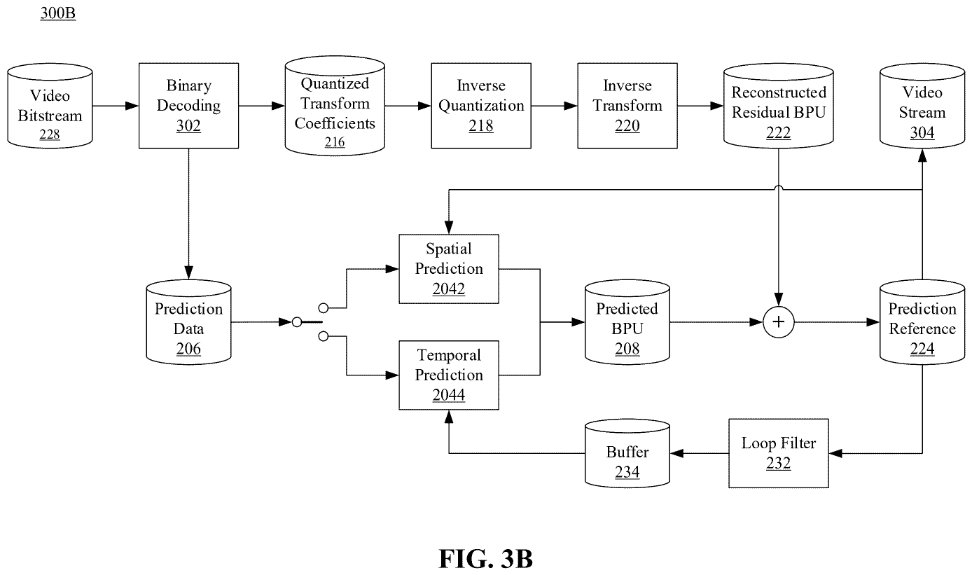

Video coding has multiple stages of operations, examples of which are shown in FIGS. 2A-2B and FIGS. 3A-3B. For each stage, the size of the basic processing units can still be too large for processing and thus can be further divided into segments referred to as “basic processing sub-units” in the present disclosure. In some embodiments, the basic processing sub-units can be referred to as “blocks” in some video coding standards (e.g., MPEG family, H.261, H.263, or H.264/AVC), or as “coding units” (“CUs”) in some other video coding standards (e.g., H.265/HEVC or H.266/VVC). A basic processing sub-unit can have the same or smaller size than the basic processing unit. Similar to the basic processing units, basic processing sub-units are also logical units, which can include a group of different types of video data (e.g., Y, Cb, Cr, and associated syntax elements) stored in a computer memory (e.g., in a video frame buffer). Any operation performed to a basic processing sub-unit can be repeatedly performed to each of its luma and chroma components. It should be noted that such division can be performed to further levels depending on processing needs. It should also be noted that different stages can divide the basic processing units using different schemes.

For example, at a mode decision stage (an example of which is shown in FIG. 2B), the encoder can decide what prediction mode (e.g., intra-picture prediction or inter-picture prediction) to use for a basic processing unit, which can be too large to make such a decision. The encoder can split the basic processing unit into multiple basic processing sub-units (e.g., CUs as in H.265/HEVC or H.266/VVC) and decide a prediction type for each individual basic processing sub-unit.

For another example, at a prediction stage (an example of which is shown in FIGS. 2A-2B), the encoder can perform prediction operation at the level of basic processing sub-units (e.g., CUs). However, in some cases, a basic processing sub-unit can still be too large to process. The encoder can further split the basic processing sub-unit into smaller segments (e.g., referred to as “prediction blocks” or “PBs” in H.265/HEVC or H.266/VVC), at the level of which the prediction operation can be performed.

For another example, at a transform stage (an example of which is shown in FIG. 2A and FIG. 2B), the encoder can perform a transform operation for residual basic processing sub-units (e.g., CUs). However, in some cases, a basic processing sub-unit can still be too large to process. The encoder can further split the basic processing sub-unit into smaller segments (e.g., referred to as “transform blocks” or “TBs” in H.265/HEVC or H.266/VVC), at the level of which the transform operation can be performed. It should be noted that the division schemes of the same basic processing sub-unit can be different at the prediction stage and the transform stage. For example, in H.265/HEVC or H.266/VVC, the prediction blocks and transform blocks of the same CU can have different sizes and numbers.

In structure 110 of FIG. 1, basic processing unit 112 is further divided into 3×3 basic processing sub-units, the boundaries of which are shown as dotted lines. Different basic processing units of the same picture can be divided into basic processing sub-units in different schemes.

In some implementations, to provide the capability of parallel processing and error resilience to video encoding and decoding, a picture can be divided into regions for processing, such that, for a region of the picture, the encoding or decoding process can depend on no information from any other region of the picture. In other words, each region of the picture can be processed independently. By doing so, the codec can process different regions of a picture in parallel, thus increasing the coding efficiency. Also, when data of a region is corrupted in the processing or lost in network transmission, the codec can correctly encode or decode other regions of the same picture without reliance on the corrupted or lost data, thus providing the capability of error resilience. In some video coding standards, a picture can be divided into different types of regions. For example, H.265/HEVC and H.266/VVC provide two types of regions: “slices” and “tiles.” It should also be noted that different pictures of video sequence 100 can have different partition schemes for dividing a picture into regions.

For example, in FIG. 1, structure 110 is divided into three regions 114, 116, and 118, the boundaries of which are shown as solid lines inside structure 110. Region 114 includes four basic processing units. Each of regions 116 and 118 includes six basic processing units. It should be noted that the basic processing units, basic processing sub-units, and regions of structure 110 in FIG. 1 are only examples, and the present disclosure does not limit embodiments thereof.

FIG. 2A illustrates a schematic diagram of an exemplary encoding process 200A, consistent with embodiments of the disclosure. For example, the encoding process 200A can be performed by an encoder. As shown in FIG. 2A, the encoder can encode video sequence 202 into video bitstream 228 according to process 200A. Similar to video sequence 100 in FIG. 1, video sequence 202 can include a set of pictures (referred to as “original pictures”) arranged in a temporal order. Similar to structure 110 in FIG. 1, each original picture of video sequence 202 can be divided by the encoder into basic processing units, basic processing sub-units, or regions for processing. In some embodiments, the encoder can perform process 200A at the level of basic processing units for each original picture of video sequence 202. For example, the encoder can perform process 200A in an iterative manner, in which the encoder can encode a basic processing unit in one iteration of process 200A. In some embodiments, the encoder can perform process 200A in parallel for regions (e.g., regions 114-118) of each original picture of video sequence 202.

In FIG. 2A, the encoder can feed a basic processing unit (referred to as an “original BPU”) of an original picture of video sequence 202 to prediction stage 204 to generate prediction data 206 and predicted BPU 208. The encoder can subtract predicted BPU 208 from the original BPU to generate residual BPU 210. The encoder can feed residual BPU 210 to transform stage 212 and quantization stage 214 to generate quantized transform coefficients 216. The encoder can feed prediction data 206 and quantized transform coefficients 216 to binary coding stage 226 to generate video bitstream 228. Components 202, 204, 206, 208, 210, 212, 214, 216, 226, and 228 can be referred to as a “forward path.” During process 200A, after quantization stage 214, the encoder can feed quantized transform coefficients 216 to inverse quantization stage 218 and inverse transform stage 220 to generate reconstructed residual BPU 222. The encoder can add reconstructed residual BPU 222 to predicted BPU 208 to generate prediction reference 224, which is used in prediction stage 204 for the next iteration of process 200A. Components 218, 220, 222, and 224 of process 200A can be referred to as a “reconstruction path.” The reconstruction path can be used to ensure that both the encoder and the decoder use the same reference data for prediction.

The encoder can perform process 200A iteratively to encode each original BPU of the original picture (in the forward path) and generate predicted reference 224 for encoding the next original BPU of the original picture (in the reconstruction path). After encoding all original BPUs of the original picture, the encoder can proceed to encode the next picture in video sequence 202.

Referring to process 200A, the encoder can receive video sequence 202 generated by a video capturing device (e.g., a camera). The term “receive” used herein can refer to receiving, inputting, acquiring, retrieving, obtaining, reading, accessing, or any action in any manner for inputting data.

At prediction stage 204, at a current iteration, the encoder can receive an original BPU and prediction reference 224 and perform a prediction operation to generate prediction data 206 and predicted BPU 208. Prediction reference 224 can be generated from the reconstruction path of the previous iteration of process 200A. The purpose of prediction stage 204 is to reduce information redundancy by extracting prediction data 206 that can be used to reconstruct the original BPU as predicted BPU 208 from prediction data 206 and prediction reference 224.

Ideally, predicted BPU 208 can be identical to the original BPU. However, due to non-ideal prediction and reconstruction operations, predicted BPU 208 is generally slightly different from the original BPU. For recording such differences, after generating predicted BPU 208, the encoder can subtract it from the original BPU to generate residual BPU 210. For example, the encoder can subtract values (e.g., greyscale values or RGB values) of pixels of predicted BPU 208 from values of corresponding pixels of the original BPU. Each pixel of residual BPU 210 can have a residual value as a result of such subtraction between the corresponding pixels of the original BPU and predicted BPU 208. Compared with the original BPU, prediction data 206 and residual BPU 210 can have fewer bits, but they can be used to reconstruct the original BPU without significant quality deterioration. Thus, the original BPU is compressed.

To further compress residual BPU 210, at transform stage 212, the encoder can reduce spatial redundancy of residual BPU 210 by decomposing it into a set of two-dimensional “base patterns,” each base pattern being associated with a “transform coefficient.” The base patterns can have the same size (e.g., the size of residual BPU 210). Each base pattern can represent a variation frequency (e.g., frequency of brightness variation) component of residual BPU 210. None of the base patterns can be reproduced from any combinations (e.g., linear combinations) of any other base patterns. In other words, the decomposition can decompose variations of residual BPU 210 into a frequency domain. Such a decomposition is analogous to a discrete Fourier transform of a function, in which the base patterns are analogous to the base functions (e.g., trigonometry functions) of the discrete Fourier transform, and the transform coefficients are analogous to the coefficients associated with the base functions.

Different transform algorithms can use different base patterns. Various transform algorithms can be used at transform stage 212, such as, for example, a discrete cosine transform, a discrete sine transform, or the like. The transform at transform stage 212 is invertible. That is, the encoder can restore residual BPU 210 by an inverse operation of the transform (referred to as an “inverse transform”). For example, to restore a pixel of residual BPU 210, the inverse transform can be multiplying values of corresponding pixels of the base patterns by respective associated coefficients and adding the products to produce a weighted sum. For a video coding standard, both the encoder and decoder can use the same transform algorithm (thus the same base patterns). Thus, the encoder can record only the transform coefficients, from which the decoder can reconstruct residual BPU 210 without receiving the base patterns from the encoder. Compared with residual BPU 210, the transform coefficients can have fewer bits, but they can be used to reconstruct residual BPU 210 without significant quality deterioration. Thus, residual BPU 210 is further compressed.

The encoder can further compress the transform coefficients at quantization stage 214. In the transform process, different base patterns can represent different variation frequencies (e.g., brightness variation frequencies). Because human eyes are generally better at recognizing low-frequency variation, the encoder can disregard information of high-frequency variation without causing significant quality deterioration in decoding. For example, at quantization stage 214, the encoder can generate quantized transform coefficients 216 by dividing each transform coefficient by an integer value (referred to as a “quantization scale factor”) and rounding the quotient to its nearest integer. After such an operation, some transform coefficients of the high-frequency base patterns can be converted to zero, and the transform coefficients of the low-frequency base patterns can be converted to smaller integers. The encoder can disregard the zero-value quantized transform coefficients 216, by which the transform coefficients are further compressed. The quantization process is also invertible, in which quantized transform coefficients 216 can be reconstructed to the transform coefficients in an inverse operation of the quantization (referred to as “inverse quantization”).

Because the encoder disregards the remainders of such divisions in the rounding operation, quantization stage 214 can be lossy. Typically, quantization stage 214 can contribute the most information loss in process 200A. The larger the information loss is, the fewer bits the quantized transform coefficients 216 can need. For obtaining different levels of information loss, the encoder can use different values of the quantization syntax element or any other syntax element of the quantization process.

At binary coding stage 226, the encoder can encode prediction data 206 and quantized transform coefficients 216 using a binary coding technique, such as, for example, entropy coding, variable length coding, arithmetic coding, Huffman coding, context-adaptive binary arithmetic coding, or any other lossless or lossy compression algorithm. In some embodiments, besides prediction data 206 and quantized transform coefficients 216, the encoder can encode other information at binary coding stage 226, such as, for example, a prediction mode used at prediction stage 204, syntax elements of the prediction operation, a transform type at transform stage 212, syntax elements of the quantization process (e.g., quantization syntax elements), an encoder control syntax element (e.g., a bitrate control syntax element), or the like. The encoder can use the output data of binary coding stage 226 to generate video bitstream 228. In some embodiments, video bitstream 228 can be further packetized for network transmission.

Referring to the reconstruction path of process 200A, at inverse quantization stage 218, the encoder can perform inverse quantization on quantized transform coefficients 216 to generate reconstructed transform coefficients. At inverse transform stage 220, the encoder can generate reconstructed residual BPU 222 based on the reconstructed transform coefficients. The encoder can add reconstructed residual BPU 222 to predicted BPU 208 to generate prediction reference 224 that is to be used in the next iteration of process 200A.

It should be noted that other variations of the process 200A can be used to encode video sequence 202. In some embodiments, stages of process 200A can be performed by the encoder in different orders. In some embodiments, one or more stages of process 200A can be combined into a single stage. In some embodiments, a single stage of process 200A can be divided into multiple stages. For example, transform stage 212 and quantization stage 214 can be combined into a single stage. In some embodiments, process 200A can include additional stages. In some embodiments, process 200A can omit one or more stages in FIG. 2A.

FIG. 2B illustrates a schematic diagram of another exemplary encoding process 200B, consistent with embodiments of the disclosure. Process 200B can be modified from process 200A. For example, process 200B can be used by an encoder conforming to a hybrid video coding standard (e.g., H.26x series). Compared with process 200A, the forward path of process 200B additionally includes mode decision stage 230 and divides prediction stage 204 into spatial prediction stage 2042 and temporal prediction stage 2044. The reconstruction path of process 200B additionally includes loop filter stage 232 and buffer 234.

Generally, prediction techniques can be categorized into two types: spatial prediction and temporal prediction. Spatial prediction (e.g., an intra-picture prediction or “intra prediction”) can use pixels from one or more already coded neighboring BPUs in the same picture to predict the current BPU. That is, prediction reference 224 in the spatial prediction can include the neighboring BPUs. The spatial prediction can reduce the inherent spatial redundancy of the picture. Temporal prediction (e.g., an inter-picture prediction or “inter prediction”) can use regions from one or more already coded pictures to predict the current BPU. That is, prediction reference 224 in the temporal prediction can include the coded pictures. The temporal prediction can reduce the inherent temporal redundancy of the pictures.

Referring to process 200B, in the forward path, the encoder performs the prediction operation at spatial prediction stage 2042 and temporal prediction stage 2044. For example, at spatial prediction stage 2042, the encoder can perform the intra prediction. For an original BPU of a picture being encoded, prediction reference 224 can include one or more neighboring BPUs that have been encoded (in the forward path) and reconstructed (in the reconstructed path) in the same picture. The encoder can generate predicted BPU 208 by extrapolating the neighboring BPUs. The extrapolation technique can include, for example, a linear extrapolation or interpolation, a polynomial extrapolation or interpolation, or the like. In some embodiments, the encoder can perform the extrapolation at the pixel level, such as by extrapolating values of corresponding pixels for each pixel of predicted BPU 208. The neighboring BPUs used for extrapolation can be located with respect to the original BPU from various directions, such as in a vertical direction (e.g., on top of the original BPU), a horizontal direction (e.g., to the left of the original BPU), a diagonal direction (e.g., to the down-left, down-right, up-left, or up-right of the original BPU), or any direction defined in the used video coding standard. For the intra prediction, prediction data 206 can include, for example, locations (e.g., coordinates) of the used neighboring BPUs, sizes of the used neighboring BPUs, syntax elements of the extrapolation, a direction of the used neighboring BPUs with respect to the original BPU, or the like.

For another example, at temporal prediction stage 2044, the encoder can perform the inter prediction. For an original BPU of a current picture, prediction reference 224 can include one or more pictures (referred to as “reference pictures”) that have been encoded (in the forward path) and reconstructed (in the reconstructed path). In some embodiments, a reference picture can be encoded and reconstructed BPU by BPU. For example, the encoder can add reconstructed residual BPU 222 to predicted BPU 208 to generate a reconstructed BPU. When all reconstructed BPUs of the same picture are generated, the encoder can generate a reconstructed picture as a reference picture. The encoder can perform an operation of “motion estimation” to search for a matching region in a scope (referred to as a “search window”) of the reference picture. The location of the search window in the reference picture can be determined based on the location of the original BPU in the current picture. For example, the search window can be centered at a location having the same coordinates in the reference picture as the original BPU in the current picture and can be extended out for a predetermined distance. When the encoder identifies (e.g., by using a pel-recursive algorithm, a block-matching algorithm, or the like) a region similar to the original BPU in the search window, the encoder can determine such a region as the matching region. The matching region can have different dimensions (e.g., being smaller than, equal to, larger than, or in a different shape) from the original BPU. Because the reference picture and the current picture are temporally separated in the timeline (e.g., as shown in FIG. 1), it can be deemed that the matching region “moves” to the location of the original BPU as time goes by. The encoder can record the direction and distance of such a motion as a “motion vector.” When multiple reference pictures are used (e.g., as picture 106 in FIG. 1), the encoder can search for a matching region and determine its associated motion vector for each reference picture. In some embodiments, the encoder can assign weights to pixel values of the matching regions of respective matching reference pictures.

The motion estimation can be used to identify various types of motions, such as, for example, translations, rotations, zooming, or the like. For inter prediction, prediction data 206 can include, for example, locations (e.g., coordinates) of the matching region, the motion vectors associated with the matching region, the number of reference pictures, weights associated with the reference pictures, or the like.

For generating predicted BPU 208, the encoder can perform an operation of “motion compensation.” The motion compensation can be used to reconstruct predicted BPU 208 based on prediction data 206 (e.g., the motion vector) and prediction reference 224. For example, the encoder can move the matching region of the reference picture according to the motion vector, in which the encoder can predict the original BPU of the current picture. When multiple reference pictures are used (e.g., as picture 106 in FIG. 1), the encoder can move the matching regions of the reference pictures according to the respective motion vectors and average pixel values of the matching regions. In some embodiments, if the encoder has assigned weights to pixel values of the matching regions of respective matching reference pictures, the encoder can add a weighted sum of the pixel values of the moved matching regions.

In some embodiments, the inter prediction can be unidirectional or bidirectional. Unidirectional inter predictions can use one or more reference pictures in the same temporal direction with respect to the current picture. For example, picture 104 in FIG. 1 is a unidirectional inter-predicted picture, in which the reference picture (e.g., picture 102) precedes picture 104. Bidirectional inter predictions can use one or more reference pictures at both temporal directions with respect to the current picture. For example, picture 106 in FIG. 1 is a bidirectional inter-predicted picture, in which the reference pictures (e.g., pictures 104 and 108) are at both temporal directions with respect to picture 104.

Still referring to the forward path of process 200B, after spatial prediction 2042 and temporal prediction stage 2044, at mode decision stage 230, the encoder can select a prediction mode (e.g., one of the intra prediction or the inter prediction) for the current iteration of process 200B. For example, the encoder can perform a rate-distortion optimization technique, in which the encoder can select a prediction mode to minimize a value of a cost function depending on a bit rate of a candidate prediction mode and distortion of the reconstructed reference picture under the candidate prediction mode. Depending on the selected prediction mode, the encoder can generate the corresponding predicted BPU 208 and predicted data 206.

In the reconstruction path of process 200B, if intra prediction mode has been selected in the forward path, after generating prediction reference 224 (e.g., the current BPU that has been encoded and reconstructed in the current picture), the encoder can directly feed prediction reference 224 to spatial prediction stage 2042 for later usage (e.g., for extrapolation of a next BPU of the current picture). The encoder can feed prediction reference 224 to loop filter stage 232, at which the encoder can apply a loop filter to prediction reference 224 to reduce or eliminate distortion (e.g., blocking artifacts) introduced during coding of the prediction reference 224. The encoder can apply various loop filter techniques at loop filter stage 232, such as, for example, deblocking, sample adaptive offsets, adaptive loop filters, or the like. The loop-filtered reference picture can be stored in buffer 234 (or “decoded picture buffer (DPB)”) for later use (e.g., to be used as an inter-prediction reference picture for a future picture of video sequence 202). The encoder can store one or more reference pictures in buffer 234 to be used at temporal prediction stage 2044. In some embodiments, the encoder can encode syntax elements of the loop filter (e.g., a loop filter strength) at binary coding stage 226, along with quantized transform coefficients 216, prediction data 206, and other information.

FIG. 3A illustrates a schematic diagram of an exemplary decoding process 300A, consistent with embodiments of the disclosure. Process 300A can be a decompression process corresponding to the compression process 200A in FIG. 2A. In some embodiments, process 300A can be similar to the reconstruction path of process 200A. A decoder can decode video bitstream 228 into video stream 304 according to process 300A. Video stream 304 can be very similar to video sequence 202. However, due to the information loss in the compression and decompression process (e.g., quantization stage 214 in FIG. 2A and FIG. 2B), generally, video stream 304 is not identical to video sequence 202. Similar to processes 200A and 200B in FIG. 2A and FIG. 2B, the decoder can perform process 300A at the level of basic processing units (BPUs) for each picture encoded in video bitstream 228. For example, the decoder can perform process 300A in an iterative manner, in which the decoder can decode a basic processing unit in one iteration of process 300A. In some embodiments, the decoder can perform process 300A in parallel for regions (e.g., regions 114-118) of each picture encoded in video bitstream 228.

In FIG. 3A, the decoder can feed a portion of video bitstream 228 associated with a basic processing unit (referred to as an “encoded BPU”) of an encoded picture to binary decoding stage 302. At binary decoding stage 302, the decoder can decode the portion into prediction data 206 and quantized transform coefficients 216. The decoder can feed quantized transform coefficients 216 to inverse quantization stage 218 and inverse transform stage 220 to generate reconstructed residual BPU 222. The decoder can feed prediction data 206 to prediction stage 204 to generate predicted BPU 208. The decoder can add reconstructed residual BPU 222 to predicted BPU 208 to generate predicted reference 224. In some embodiments, predicted reference 224 can be stored in a buffer (e.g., a decoded picture buffer in a computer memory). The decoder can feed predicted reference 224 to prediction stage 204 for performing a prediction operation in the next iteration of process 300A.

The decoder can perform process 300A iteratively to decode each encoded BPU of the encoded picture and generate predicted reference 224 for encoding the next encoded BPU of the encoded picture. After decoding all encoded BPUs of the encoded picture, the decoder can output the picture to video stream 304 for display and proceed to decode the next encoded picture in video bitstream 228.

At binary decoding stage 302, the decoder can perform an inverse operation of the binary coding technique used by the encoder (e.g., entropy coding, variable length coding, arithmetic coding, Huffman coding, context-adaptive binary arithmetic coding, or any other lossless compression algorithm). In some embodiments, besides prediction data 206 and quantized transform coefficients 216, the decoder can decode other information at binary decoding stage 302, such as, for example, a prediction mode, syntax elements of the prediction operation, a transform type, syntax elements of the quantization process (e.g., quantization syntax elements), an encoder control syntax element (e.g., a bitrate control syntax element), or the like. In some embodiments, if video bitstream 228 is transmitted over a network in packets, the decoder can depacketize video bitstream 228 before feeding it to binary decoding stage 302.

FIG. 3B illustrates a schematic diagram of another exemplary decoding process 300B, consistent with embodiments of the disclosure. Process 300B can be modified from process 300A. For example, process 300B can be used by a decoder conforming to a hybrid video coding standard (e.g., H.26x series). Compared with process 300A, process 300B additionally divides prediction stage 204 into spatial prediction stage 2042 and temporal prediction stage 2044 and additionally includes loop filter stage 232 and buffer 234.

In process 300B, for an encoded basic processing unit (referred to as a “current BPU”) of an encoded picture (referred to as a “current picture”) that is being decoded, prediction data 206 decoded from binary decoding stage 302 by the decoder can include various types of data, depending on what prediction mode was used to encode the current BPU by the encoder. For example, if intra prediction was used by the encoder to encode the current BPU, prediction data 206 can include a prediction mode indicator (e.g., a flag value) indicative of the intra prediction, syntax elements of the intra prediction operation, or the like. The syntax elements of the intra prediction operation can include, for example, locations (e.g., coordinates) of one or more neighboring BPUs used as a reference, sizes of the neighboring BPUs, syntax elements of extrapolation, a direction of the neighboring BPUs with respect to the original BPU, or the like. For another example, if inter prediction was used by the encoder to encode the current BPU, prediction data 206 can include a prediction mode indicator (e.g., a flag value) indicative of the inter prediction, syntax elements of the inter prediction operation, or the like. The syntax elements of the inter prediction operation can include, for example, the number of reference pictures associated with the current BPU, weights respectively associated with the reference pictures, locations (e.g., coordinates) of one or more matching regions in the respective reference pictures, one or more motion vectors respectively associated with the matching regions, or the like.

Based on the prediction mode indicator, the decoder can decide whether to perform a spatial prediction (e.g., the intra prediction) at spatial prediction stage 2042 or a temporal prediction (e.g., the inter prediction) at temporal prediction stage 2044. The details of performing such spatial prediction or temporal prediction are described in FIG. 2B and will not be repeated hereinafter. After performing such spatial prediction or temporal prediction, the decoder can generate predicted BPU 208. The decoder can add predicted BPU 208 and reconstructed residual BPU 222 to generate prediction reference 224, as described in FIG. 3A.

In process 300B, the decoder can feed predicted reference 224 to spatial prediction stage 2042 or temporal prediction stage 2044 for performing a prediction operation in the next iteration of process 300B. For example, if the current BPU is decoded using the intra prediction at spatial prediction stage 2042, after generating prediction reference 224 (e.g., the decoded current BPU), the decoder can directly feed prediction reference 224 to spatial prediction stage 2042 for later usage (e.g., for extrapolation of a next BPU of the current picture). If the current BPU is decoded using the inter prediction at temporal prediction stage 2044, after generating prediction reference 224 (e.g., a reference picture in which all BPUs have been decoded), the decoder can feed prediction reference 224 to loop filter stage 232 to reduce or eliminate distortion (e.g., blocking artifacts). The decoder can apply a loop filter to prediction reference 224, in a way as described in FIG. 2B. The loop-filtered reference picture can be stored in buffer 234 (e.g., a decoded picture buffer (DPB) in a computer memory) for later use (e.g., to be used as an inter-prediction reference picture for a future encoded picture of video bitstream 228). The decoder can store one or more reference pictures in buffer 234 to be used at temporal prediction stage 2044. In some embodiments, prediction data can further include syntax elements of the loop filter (e.g., a loop filter strength). In some embodiments, prediction data includes syntax elements of the loop filter when the prediction mode indicator of prediction data 206 indicates that inter prediction was used to encode the current BPU.

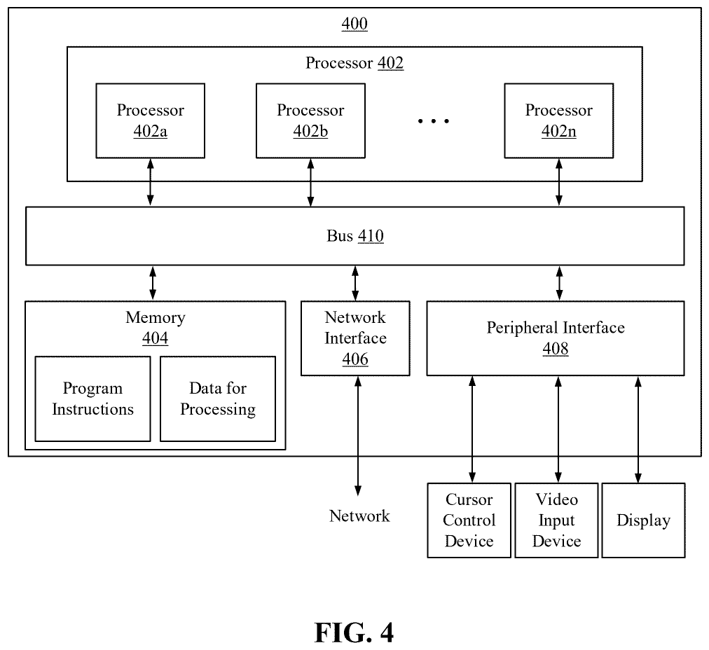

FIG. 4 is a block diagram of an exemplary apparatus 400 for encoding or decoding a video, consistent with embodiments of the disclosure. As shown in FIG. 4, apparatus 400 can include processor 402. When processor 402 executes instructions described herein, apparatus 400 can become a specialized machine for video encoding or decoding. Processor 402 can be any type of circuitry capable of manipulating or processing information. For example, processor 402 can include any combination of any number of a central processing unit (or “CPU”), a graphics processing unit (or “GPU”), a neural processing unit (“NPU”), a microcontroller unit (“MCU”), an optical processor, a programmable logic controller, a microcontroller, a microprocessor, a digital signal processor, an intellectual property (IP) core, a Programmable Logic Array (PLA), a Programmable Array Logic (PAL), a Generic Array Logic (GAL), a Complex Programmable Logic Device (CPLD), a Field-Programmable Gate Array (FPGA), a System On Chip (SoC), an Application-Specific Integrated Circuit (ASIC), or the like. In some embodiments, processor 402 can also be a set of processors grouped as a single logical component. For example, as shown in FIG. 4, processor 402 can include multiple processors, including processor 402a, processor 402b, and processor 402n.

Apparatus 400 can also include memory 404 configured to store data (e.g., a set of instructions, computer codes, intermediate data, or the like). For example, as shown in FIG. 4, the stored data can include program instructions (e.g., program instructions for implementing the stages in processes 200A, 200B, 300A, or 300B) and data for processing (e.g., video sequence 202, video bitstream 228, or video stream 304). Processor 402 can access the program instructions and data for processing (e.g., via bus 410) and execute the program instructions to perform an operation or manipulation on the data for processing. Memory 404 can include a high-speed random-access storage device or a non-volatile storage device. In some embodiments, memory 404 can include any combination of any number of a random-access memory (RAM), a read-only memory (ROM), an optical disc, a magnetic disk, a hard drive, a solid-state drive, a flash drive, a security digital (SD) card, a memory stick, a compact flash (CF) card, or the like. Memory 404 can also be a group of memories (not shown in FIG. 4) grouped as a single logical component.

Bus 410 can be a communication device that transfers data between components inside apparatus 400, such as an internal bus (e.g., a CPU-memory bus), an external bus (e.g., a universal serial bus port, a peripheral component interconnect express port), or the like.

For ease of explanation without causing ambiguity, processor 402 and other data processing circuits are collectively referred to as a “data processing circuit” in this disclosure. The data processing circuit can be implemented entirely as hardware, or as a combination of software, hardware, or firmware. In addition, the data processing circuit can be a single independent module or can be combined entirely or partially into any other component of apparatus 400.

Apparatus 400 can further include network interface 406 to provide wired or wireless communication with a network (e.g., the Internet, an intranet, a local area network, a mobile communications network, or the like). In some embodiments, network interface 406 can include any combination of any number of a network interface controller (NIC), a radio frequency (RF) module, a transponder, a transceiver, a modem, a router, a gateway, a wired network adapter, a wireless network adapter, a Bluetooth adapter, an infrared adapter, a near-field communication (“NFC”) adapter, a cellular network chip, or the like.

In some embodiments, optionally, apparatus 400 can further include peripheral interface 408 to provide a connection to one or more peripheral devices. As shown in FIG. 4, the peripheral device can include, but is not limited to, a cursor control device (e.g., a mouse, a touchpad, or a touchscreen), a keyboard, a display (e.g., a cathode-ray tube display, a liquid crystal display, or a light-emitting diode display), a video input device (e.g., a camera or an input interface coupled to a video archive), or the like.

It should be noted that video codecs (e.g., a codec performing process 200A, 200B, 300A, or 300B) can be implemented as any combination of any software or hardware modules in apparatus 400. For example, some or all stages of process 200A, 200B, 300A, or 300B can be implemented as one or more software modules of apparatus 400, such as program instructions that can be loaded into memory 404. For another example, some or all stages of process 200A, 200B, 300A, or 300B can be implemented as one or more hardware modules of apparatus 400, such as a specialized data processing circuit (e.g., an FPGA, an ASIC, an NPU, or the like).

After VVC, the JVET starts to explore coding techniques beyond VVC using an Enhanced Compression Model (ECM). The ECM is used as a new software base for developing tools beyond the VVC standard.

In VVC, a mode called Geometric partitioning mode (GPM) is supported. In the GPM mode, a geometric partitioning mode is supported for inter prediction. The geometric partitioning mode is signaled using a CU-level flag as one kind of merge mode, with other merge modes including the regular merge mode, the merge motion vector differences (MMVD) mode, the CIIP mode and the subblock merge mode. In total 64 partitions are supported by geometric partitioning mode for each possible CU size with excluding 8×64 and 64×8.

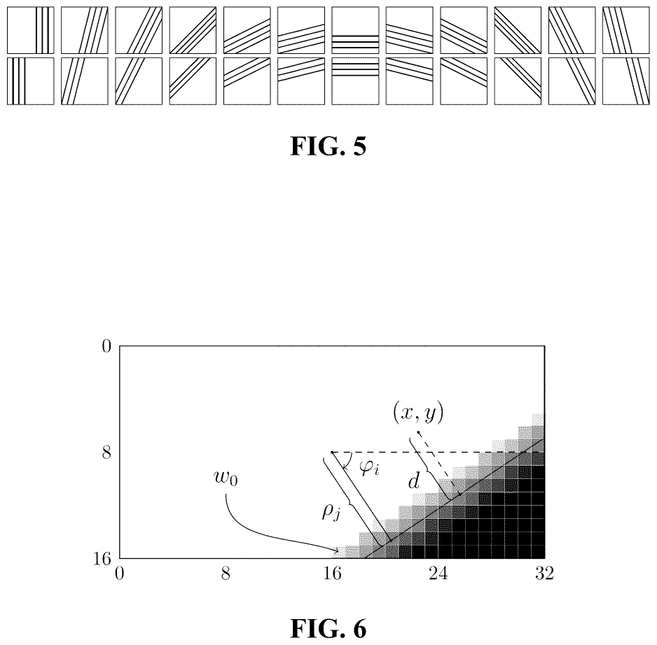

When GPM is used, a CU is split into two parts by a geometrically located straight line. FIG. 5 illustrates examples of the GPM splits grouped by identical angles, according to some embodiments of the present disclosure. As shown in FIG. 5, the location of the splitting line is mathematically derived from the angle and offset parameters of a specific partition. Each part of a geometric partition in the CU is predicted using its own motion.

If geometric partitioning mode is used for the current CU, then a geometric partition index indicating the partition mode of the geometric partition (angle and offset), and two merge indices (one for each partition) are further signaled. The number of maximum GPM candidate size is signaled explicitly in Sequence Parameter Set (SPS) and specifies syntax binarization for GPM merge indices. After predicting each part of the geometric partition, the sample values along the geometric partition edge are adjusted using a blending processing with adaptive weights. This is the prediction signal for the whole CU, and transform and quantization process will be applied to the whole CU as in other prediction modes.

Motion field storage used for the geometric partitioning mode is described. In VVC, Mv1 from the first part of the geometric partition, Mv2 from the second part of the geometric partition and a combined Mv of Mv1 and Mv2 are stored in the motion filed of a geometric partitioning mode coded CU.

The stored motion vector type for each individual position in the motion filed are determined as Equation 1:

$$sType = abs ( motionIdx ) < 32 ? 2 : ( motionIdx \leq 0 ? ( 1 - partIdx ) : partIdx ) \qquad ( 1 )$$

where motionIdx is equal to d (4x+2, 4y+2), which is recalculated from Equation 2 below. The partIdx depends on the angle index i.

If sType is equal to 0 or 1, Mv0 or Mv1 are stored in the corresponding motion field, otherwise if sType is equal to 2, a combined Mv from Mv0 and Mv2 are stored. The combined Mv are generated using the following process: 1) If Mv1 and Mv2 are from different reference picture lists (one from L0 and the other from L1), then Mv1 and Mv2 are simply combined to form the bi-prediction motion vectors. 2) Otherwise, if Mv1 and Mv2 are from the same list, only uni-prediction motion Mv2 is stored.

Blending along the geometric partitioning edge is described. In VVC, after predicting each part of a geometric partition using its own motion, blending is applied to the two prediction signals to derive samples around geometric partition edge. The blending weight for each position of the CU is derived based on the distance between individual position and the partition edge. The distance for a position (x, y) to the partition edge is derived as:

$$d ( x , y ) = ( 2 x + 1 - w ) cos ( {φ}_{i} ) + ( 2 y + 1 - h ) sin ( {φ}_{i} ) - {ρ}_{j} \qquad ( 2 )$$

$${ρ}_{j} = {ρ}_{x , j} cos ( {φ}_{i} ) + {ρ}_{y , j} sin ( {φ}_{i} ) \qquad ( 3 )$$

$${ρ}_{x , j} = \{ \begin{matrix}0 & i \% 16 = 8 or ( i \% 16 \neq 0 and h \geq w ) \\ \pm ( j \times w ) ≫ 2 & otherwise\end{matrix} \qquad ( 4 )$$

$${ρ}_{y , j} = \{ \begin{matrix}\pm ( j \times h ) ≫ 2 & i \% 16 = 8 or ( i \% 16 \neq 0 and h \geq w ) \\ 0 & otherwise\end{matrix} \qquad ( 5 )$$

where i, j are the indices for angle and offset of a geometric partition, which depend on the signaled geometric partition index. The sign of ρ_{x,j} and ρ_{y,j} depend on angle index i.

The weights for each part of a geometric partition are derived as followings:

$$wIdxL ( x , y ) = partIdx ? 32 + d ( x , y ) : 32 - d ( x , y ) \qquad ( 6 )$$

$${w}_{0} ( x , y ) = \frac{C lip 3 ( 0 , 8 , ( wIdx L ( x , y ) + 4 ) ≫ 3 )}{8} \qquad ( 7 )$$

$${w}_{1} ( x , y ) = 1 - {w}_{0} ( x , y ) \qquad ( 8 )$$

The partIdx depends on the angle index i. FIG. 6 illustrates an exemplary generation of a bending weight w₀ using geometric partitioning mode, according to some embodiments of the present disclosure.

GPM adaptive blending is described. In VVC, the final prediction samples are generated by blending the prediction of the two prediction signals using weighted average. Two integer blending matrices (W0 and W1) are used. The weights in the GPM blending matrices are derived from the ramp function based on the displacement from a predicted sample position to the GPM partitioning boundary. The blending area size is fixed to two (2 samples on each side of the GPM partition split boundary).

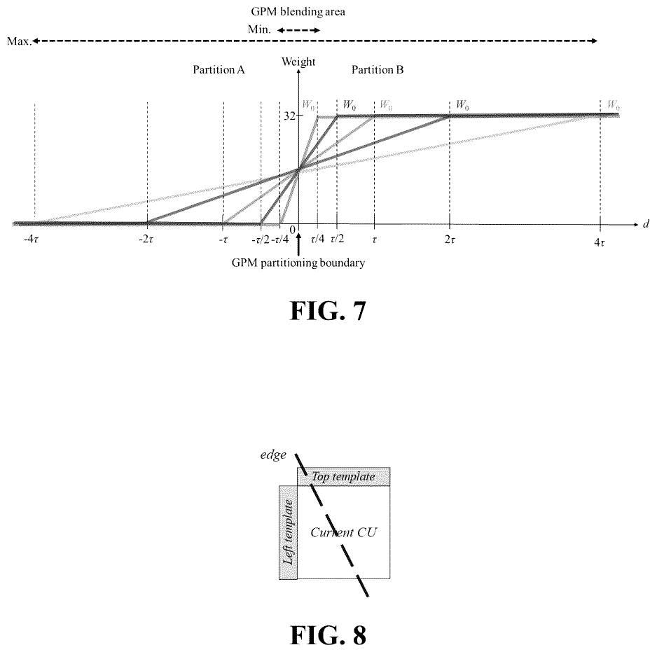

In ECM, adaptive blending is adopted for GPM mode. FIG. 7 illustrates a ramp function for the weights for GPM blending based on the displacement (d) from a predicted sample position to the GPM partitioning boundary and the blending area size (τ), according to some embodiments of the present disclosure. As shown in FIG. 7, besides the existing blending area, extra blending area sizes, i.e., quarter, half, double, and quadrupole of the existing area size (τ/4, τ/2, 2τ, and 4τ), are added for the GPM mode. The selected blending area size is signaled at CU-level from encoder to decoder. Furthermore, the extended weighting precision is proposed, that is the maximum value of the weighs is changed from 8 to 32 to accommodate the extended blending area sizes.

The weights for a geometric partition and the prediction pixel are derived as the following:

$$w ( x , y ) = \{ \begin{matrix}0 & d ( x , y ) \leq - {α}_{i} τ \\ \frac{32}{2 {α}_{i} τ} ( d ( x , y ) + {α}_{i} τ & - {α}_{i} τ \leq d ( x , y ) \leq {α}_{i} τ \\ 32 & d ( x , y ) \geq {α}_{i} τ\end{matrix} \qquad ( 9 )$$

$$p ( x , y ) = ( w ( x , y ) * A ( x , y ) + ( 32 - w ( x , y ) ) * B ( x , y ) + 16 ) ≫ 5 \qquad ( 10 )$$

where A(x, y) and B(x, y) represent the prediction sample values at the coordinate (x, y) within the block referred by MV0 and MV1 prediction.

Template matching based reordering for GPM split modes is described. In template matching based reordering for GPM split modes, given the motion information of the current GPM block, the respective TM cost values of GPM split modes are computed. Then, all GPM split modes are reordered in ascending ordering based on the TM cost values. Instead of sending GPM split mode, an index using Golomb-Rice code to indicate where the exact GPM split mode located in the reordering list is signaled.

The reordering method for GPM split modes is a two-step process performed after the respective reference templates of the two GPM partitions in a coding unit are generated, as follows:
extending GPM partition edge into the reference templates of the two GPM partitions, resulting in 64 reference templates and computing the respective TM cost for each of the 64 reference templates;
reordering GPM split modes based on their TM cost values in ascending order and marking the best 32 split modes as available split modes.

FIG. 8 illustrates an exemplary edge on templates, according to some embodiments of the present disclosure. As shown in FIG. 8, the edge on the template is extended from that of the current CU, but GPM blending process is not used in the template area across the edge.

After ascending reordering using TM cost, an index is signaled. In some embodiments, after ascending reordering using TM cost, an index is signaled using Golomb-Rice code (with divisor 4) to indicate the use of GPM split mode. Table 1 below shows the binary code of each index.

TABLE 1
Binary code for GPM index

Binary code

| Index | Prefix | Suffix |
|---|---|---|
| 0-3 | 0 | 00-11 |
| 4-7 | 10 | 00-11 |
| 8-11 | 110 | 00-11 |
| . . . | . . . | . . . |
| 28-31 | 1111 111 | 00-11 |

Geometric partitioning mode (GPM) with template matching (TM) is described. When GPM mode is enabled for a CU, a CU-level flag is signaled to indicate whether TM is applied to both geometric partitions. Motion information for each geometric partition is refined using TM. When TM is chosen, a template is constructed using left, above or left and above neighboring samples according to partition angle, as shown in Table 2. The motion is then refined by minimizing the difference between the current template and the template in the reference picture using the same search pattern of merge mode with half-pel interpolation filter disabled.

TABLE 2
Template for the 1st and 2nd geometric partitions, where A represents using above samples,
L represents using left samples, and L + A represents using both left and above samples.

| Partition | | | | | | | | | | |
|---|---|---|---|---|---|---|---|---|---|---|
| angle | 0 | 2 | 3 | 4 | 5 | 8 | 11 | 12 | 13 | 14 |
| 1st partition | A | A | A | A | L + A | L + A | L + A | L + A | A | A |
| 2nd partition | L + A | L + A | L + A | L | L | L | L | L + A | L + A | L + A |
| Partition | | | | | | | | | | |
| angle | 16 | 18 | 19 | 20 | 21 | 24 | 27 | 28 | 29 | 30 |
| 1st partition | A | A | A | A | L + A | L + A | L + A | L + A | A | A |
| 2nd partition | L + A | L + A | L + A | L | L | L | L | L + A | L + A | L + A |

A GPM candidate list is constructed as follows: 1) Interleaved List-0 MV candidates and List-1 MV candidates are derived directly from the regular merge candidate list, where List-0 MV candidates are higher priority than List-1 MV candidates. A pruning method with an adaptive threshold based on the current CU size is applied to remove redundant MV candidates. 2) Interleaved List-1 MV candidates and List-0 MV candidates are further derived directly from the regular merge candidate list, where List-1 MV candidates are higher priority than List-0 MV candidates. The same pruning method with the adaptive threshold is also applied to remove redundant MV candidates. 3) Zero MV candidates are padded until the GPM candidate list is full.

The GPM-MMVD and GPM-TM are exclusively enabled to one GPM CU. The GPM-MMVD syntax is signaled. When both two GPM-MMVD control flags are equal to false (i.e., the GPM-MMVD are disabled for two GPM partitions), the GPM-TM flag is signaled to indicate whether the template matching is applied to the two GPM partitions. Otherwise (at least one GPM-MMVD flag is equal to true), the value of the GPM-TM flag is inferred to be false.

Geometric partitioning mode (GPM) with merge motion vector differences (MMVD) is described. GPM in VVC is extended by applying motion vector refinement on top of the existing GPM uni-directional MVs. A flag is first signaled for a GPM CU, to specify whether this mode is used. If the mode is used, each geometric partition of a GPM CU can further decide whether to signal MVD or not. If MVD is signaled for a geometric partition, after a GPM merge candidate is selected, the motion of the partition is further refined by the signaled MVDs information. All other procedures are kept the same as in GPM.

The MVD is signaled as a pair of distance and direction, similar as in MMVD. There are nine candidate distances (¼-pel, ½-pel, 1-pel, 2-pel, 3-pel, 4-pel, 6-pel, 8-pel, 16-pel), and eight candidate directions (four horizontal/vertical directions and four diagonal directions) involved in GPM with MMVD (GPM-MMVD). In addition, when pic_fpel_mmvd_enabled_flag is equal to 1, the MVD is left shifted by 2 as in MMVD.

Bi-predictive GPM is described. The GPM design in VVC relies on uni-predictive motion vectors to generate motion compensated prediction samples for each inter GPM partition. In ECM, such a design has been extended to allow usage of bi-predictive motion vectors.

When constructing a GPM candidate list, the extraction process that extracts uni-predictive motion vectors from the initial merge list is invoked only for small blocks 8×8, 16×8 and 8×16. For larger blocks, the extraction process is bypassed, so the initial merge list (which may contain merged Bi-MVs) is directly used as the final GPM merge list. The generation of the initial merge list is the same as before (i.e., the normal merge list generation without any candidate reordering) except that when generating the initial merge list for larger blocks (i.e., blocks with the extraction process bypassed), the motion vector difference threshold for controlling whether a candidate can be added into the list is increased to be one full sample distance.

In some embodiment, bi-directional optical flow (BDOF) based motion vector refinement as in the multi-pass DMVR is used when generating motion compensated prediction samples.

When GPM-MMVD is used for a GPM partition and its base motion vector is bi-predictive, for low-delay pictures, the signaled MVD is applied on top of the L0 and L1 motion vector as in the existing merge MMVD design. For non-low-delay pictures, the bi-predictive motion vector is converted into a uni-predictive motion vector first and then the MVD is applied on top.

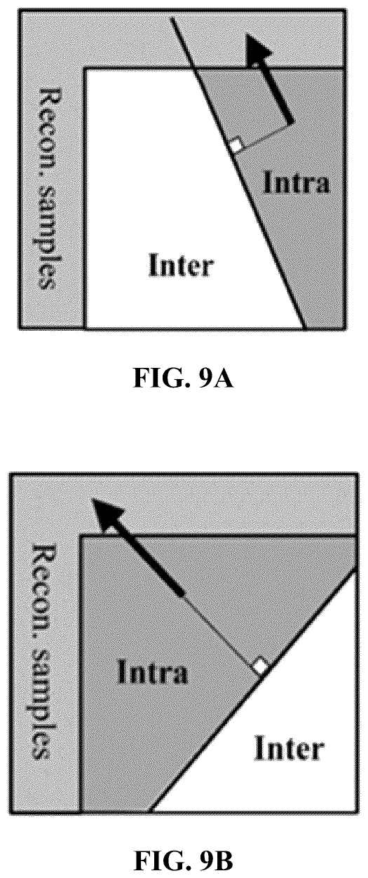

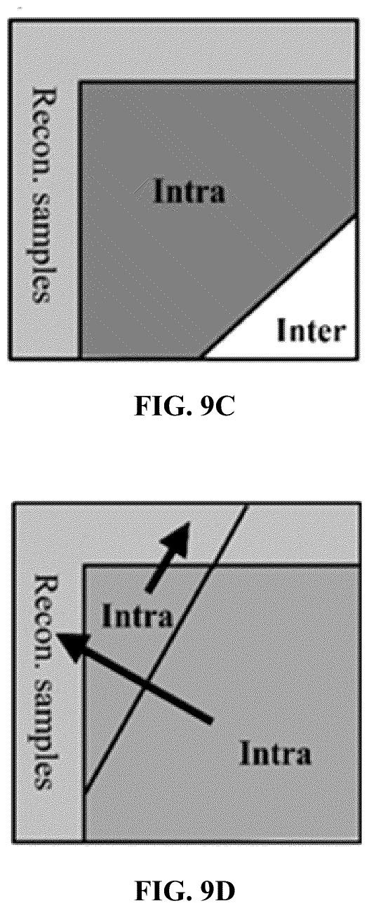

GPM with intra and inter prediction is described. In GPM with intra and inter prediction, the final prediction samples are generated by weighting inter predicted samples and intra predicted samples for each GPM-separated region. The inter predicted samples are derived by inter GPM whereas the intra predicted samples are derived by an intra prediction mode (IPM) candidate list and an index signaled from the encoder. The IPM candidate list size is pre-defined as 3. FIGS. 9A-9C are schematic diagrams illustrating available IPM candidate for the GPM. FIG. 9A shows the parallel angular mode against the GPM block boundary (i.e., parallel mode). FIG. 9B shows the perpendicular angular mode against the GPM block boundary (i.e., perpendicular mode). And FIG. 9C shows the planar mode. Furthermore, FIG. 9D illustrates GPM with intra and intra prediction, which is restricted to reduce the signaling overhead for IPMs and avoid an increase in the size of the intra prediction circuit on the hardware decoder. In addition, a direct motion vector and IPM storage on the GPM-blending area is introduced to further improve the coding performance.

In DIMD and neighboring mode based IPM derivation Parallel mode is registered first. Therefore, max two IPM candidates derived from the decoder-side intra mode derivation (DIMD) method and/or the neighboring blocks can be registered if there is not the same IPM candidate in the list. As for the neighboring mode derivation, there are five positions for available neighboring blocks at most, but they are restricted by the angle of GPM block boundary as shown in Table 3, which are already used for GPM with template matching (GPM-TM).

TABLE 3
The position of available neighboring blocks for IPM candidate derivation based on the angle
of GPM block boundary. A and L denote the above and left side of the prediction block.

| Angle of | | | | | | | | | | |
|---|---|---|---|---|---|---|---|---|---|---|
| GPM | 0 | 2 | 3 | 4 | 5 | 8 | 11 | 12 | 13 | 14 |
| 1st partition | A | A | A | A | L + A | L + A | L + A | L + A | A | A |
| 2nd partition | L + A | L + A | L + A | L | L | L | L | L + A | L + A | L + A |
| Partition | | | | | | | | | | |
| angle | 16 | 18 | 19 | 20 | 21 | 24 | 27 | 28 | 29 | 30 |
| 1st partition | A | A | A | A | L + A | L + A | L + A | L + A | A | A |
| 2nd partition | L + A | L + A | L + A | L | L | L | L | L + A | L + A | L + A |

GPM-intra can be combined with GPM with motion vector difference (GPM-MMVD). TIMD is used for IPM candidates of GPM-intra to further improve the coding performance. The Parallel mode can be registered first, then IPM candidates of TIMD, DIMD, and neighboring blocks.

Consistent with the disclosed embodiments, in the implicit GPM, the two integer blending matrices (i.e., W0 and W1) are derived from the template (e.g., 1 line above, 1 column left). The blending matrices are modelled as an affine linear function of the sample positions (x,y) in the current CU:

$$W 0 ( x , y ) = a . x + b . y + c \qquad ( 12 )$$

$$W 1 ( x , y ) = 1 - W 0 ( x , y ) \qquad ( 13 )$$

The parameters (a,b,c) are derived from the reference template using the same solver (MSE minimization) as the one used for Convolutional Cross-Component Model (CCCM), Gradient Linear Model (GLM) or Gradient and Location based Convolutional Cross-Component Model (GL-CCCM). A list of motion pair candidates is constructed from the regular GPM candidates and re-ordered with the template matching (TM) cost.

The implicit GPM mode is signaled by a CU-level flag (gpm_implicit_flag). If gpm_implicit_flag is true, a merge-index is coded to signal the pair of GPM candidates to be used. If gpm_implicit_flag is false, the regular GPM syntax elements are signaled.

Affine motion compensation combined with geometric partition mode (AMC-GPM) is described. In ECM, the GPM is further extended to enable affine motion compensation (AMC). Therefore, a GPM partition can be predicted by AMC inter-prediction, non-AMC inter-prediction or intra-prediction. In addition, a GPM partition predicted by AMC can be combined with the other GPM partition predicted by AMC, non-AMC, or intra-prediction.

When AMC is applied, a uni-prediction affine merge candidate list is constructed from the subblock-based merge candidate list after discarding sub-TMVP candidates, similar to the uni-prediction merge candidate list construction for GPM in VVC. AMC is performed for a GPM partition using the control point motion vectors (CPMVs) of a merge candidate in the uni-prediction affine merge candidate list. The length of the uni-prediction affine merge candidate list is signaled in SPS. When ARMC is applicable, the uni-prediction affine merge candidate list is reordered according to the TM costs.

A gpm_affine_flag is signaled for each GPM partition to indicate whether AMC is applied for the GPM partition. A merge candidate index for the GPM partition is signaled using individual arithmetic context models depending on whether AMC or non-AMC is applied.

For current design, AMC is not allowed for GPM-MMVD and GPM-TM.

The current design of the geometric partitioning mode (GPM) still has some problems. For example, in the current design, the intra and inter prediction have been applied to the GPM. When GPM mode is enabled for a CU, the final prediction samples can be generated by weighting inter predicted samples and intra predicted samples for each GPM-separated region. When implicit GPM mode is enabled for a CU, the final prediction samples are generated by weighting inter predicted samples for two partitions, which leads to the lower prediction accuracy without intra and inter prediction.

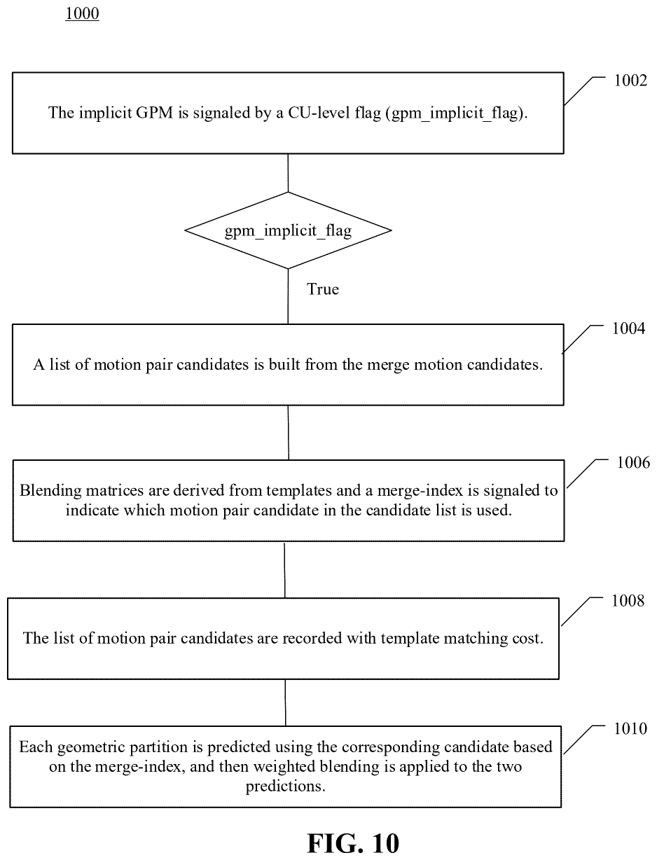

FIG. 10 is a flow chart of an exemplary method 1000 for implicit GPM, according to some embodiments of the present disclosure. Method 1000 can be performed by an encoder (e.g., by process 200A of FIG. 2A or 200B of FIG. 2B), a decoder (e.g., by process 300A of FIG. 3A or 300B of FIG. 3B) or performed by one or more software or hardware components of an apparatus (e.g., apparatus 400 of FIG. 4). For example, a processor (e.g., processor 402 of FIG. 4) can perform method 1000. In some embodiments, method 1000 can be implemented by a computer program product, embodied in a computer-readable medium, including computer-executable instructions, such as program code, executed by computers (e.g., apparatus 400 of FIG. 4). Referring to FIG. 10, method 1000 may include the following steps 1002 to 1006.

In the current design, when the implicit GPM is chosen, method 1000 is performed. In some embodiments, whether to perform the implicit GPM is determined in an explicit mode. For example, a CU-level flag (gpm_implicit_flag) is signaled to indicate whether the implicit GPM is chosen. When the flag is true, i.e., a value of the flag is equal to a first value, for example “1,” the implicit GPM is chosen, step 1002 is performed.

At step 1002, a list of motion pair candidates is constructed from the merge motion vector candidates. One pair candidates includes a pair of motion vectors.

At step 1004, blending matrices are derived from templates and a merge-index is signaled to indicate which motion pair candidate in the candidate list to be used. The motion pair candidate in the list indicates the motion vectors of two geometric partitions (i.e., the first motion in the motion pair candidate indicates the motion of the first partition, the second motion in the motion pair candidate indicates the motion of the second partition). The two integer blending matrices (W0 and W1) for the used motion pair candidate are derived from the template (e.g., 1 line above, 1 column left).

At step 1006, the list of motion pair candidates is recorded with template matching cost.

At step 1008, each geometric partition is predicted using the corresponding candidate based on the merge-index, and then weighted blending is applied to the two predictions.

The improvements to implicit GPM described in the following exemplary embodiments can solve one or more of the above-described problems.

Embodiments of the present disclosure provide methods for applying intra and inter prediction to implicit GPM.

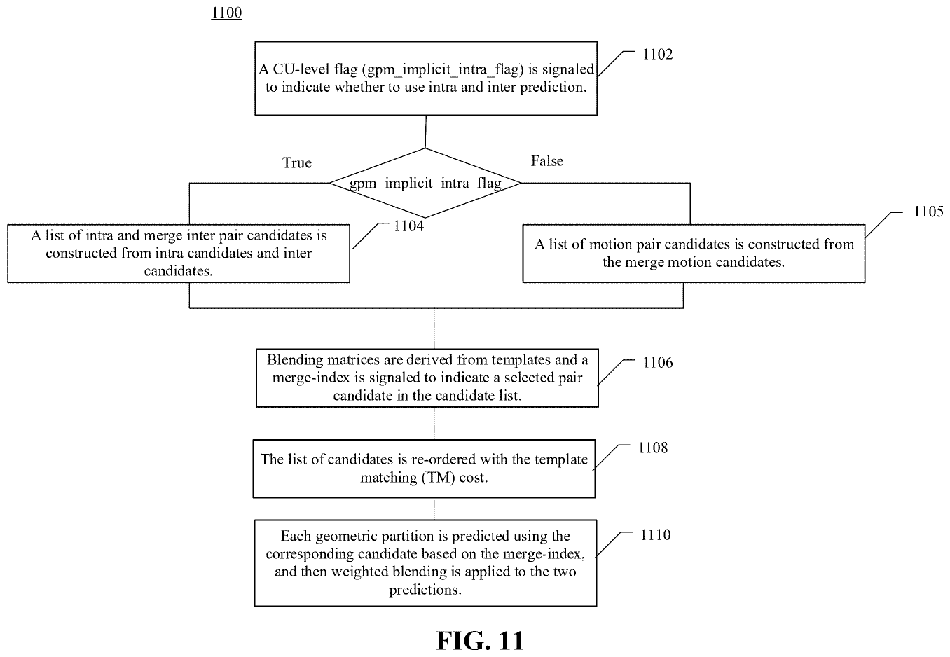

In some embodiments, whether to apply the intra and inter prediction mode to implicit GPM is determined an explicit mode. FIG. 11 is a flowchart of an exemplary method 1100 for implicit GPM with intra and inter prediction, according to some embodiments of the present disclosure. Method 1100 can be performed by an encoder (e.g., by process 200A of FIG. 2A or 200B of FIG. 2B), a decoder (e.g., by process 300A of FIG. 3A or 300B of FIG. 3B) or performed by one or more software or hardware components of an apparatus (e.g., apparatus 400 of FIG. 4). For example, a processor (e.g., processor 402 of FIG. 4) can perform method 1100. In some embodiments, method 1100 can be implemented by a computer program product, embodied in a computer-readable medium, including computer-executable instructions, such as program code, executed by computers (e.g., apparatus 400 of FIG. 4). Referring to FIG. 11, method 1100 may include the following steps 1102 to 1110.

Referring to FIG. 11, when the implicit GPM mode is chosen, at step 1102, a CU-level flag (gpm_implicit_intra_flag) is signaled to indicate whether to use an intra and inter prediction. When the flag (i.e., gpm_implicit_intra_flag) is true, i.e., a value of the flag is equal to a first value, for example “1,” the intra and inter prediction is applied to the implicit GPM. When the flag (i.e., gpm_implicit_intra_flag) is false, i.e., a value of the flag is equal to a second value, for example “0,” the intra and inter prediction is not applied to the implicit GPM.

When the flag is true, that is, the intra and inter prediction is applied to the implicit GPM, step 1104 is performed. At step 1104, a list of intra and merge inter pair candidates is constructed from intra candidates and inter candidates. In some embodiments, intra candidates are derived from the most probable modes (MPM) list and inter candidates are derived from merge motion vector list. In this example, the inter candidates are merge motion vector candidates. The intra modes in the MPM list are derived from the adjacent blocks, decoder-side intra mode derivation (DIMD), non-adjacent blocks, and default intra prediction modes, sequentially. The first n intra modes in the MPM list are chosen, n is a number smaller than the max number of intra modes in the MPM list, for example, n is 22. Then the list of intra and merge inter pair candidates is constructed from the intra candidates and inter candidates. In the list of intra and merge inter pair candidates, a pair candidate can include an intra candidate for the first partition and an inter candidate the second partition; or an inter candidate for the first partition and an inter candidate for the second partition.

When the flag is false, that is, the intra and inter prediction is not applied to the implicit GPM, step 1105 is performed. At step 1105, a list of motion pair candidates is constructed from the merge motion vector candidates, which is the same as step 1002 in method 1000 with reference to FIG. 10, which will not be repeated herein.

At step 1106, blending matrices are derived from templates and a merge-index is signaled to indicate a selected pair candidate in the candidate list. The selected pair candidate is to be used for the prediction. The two integer blending matrices (W0 and W1) are derived from the template (e.g., 1 line above, 1 column left). The blending matrices are modelled as an affine linear function of the sample positions (x,y) in the current CU:

$$W 0 ( x , y ) = a . x + b . y + c \qquad ( 14 )$$

$$W 1 ( x , y ) = 1 - W 0 ( x , y ) \qquad ( 15 )$$

The parameters (a,b,c) are derived from the reference template using the same solver (MSE minimization) as the one used for CCCM, GLM or GL-CCCM.

At step 1108, the list of candidates is re-ordered with the template matching (TM) cost.

At step 1110, each geometric partition is predicted using the corresponding candidate based on the merge-index, and then weighted blending is applied to the two predictions. Then a final predicted coding block is obtained. When step 1104 is performed, i.e., the intra and inter prediction is applied to the implicit GPM, then a first partition of the CU is predicted using inter prediction and a second partition of the CU is predicted using intra prediction. For the inter prediction partition, overlapped block motion compensation (OBMC) and luma mapping with chroma scaling (LMCS) are performed after motion compensation. Then the final prediction samples are generated by weighting inter predicted samples and intra predicted sample with W0 and W1 matrices.

When the flag (i.e., gpm_implicit_intra_flag) is false, after step 1105, the subsequent steps (e.g., steps 1106 to 1110) are the same as those (e.g., steps 1006-1010) described above with reference to FIG. 10, which will not be repeated herein.

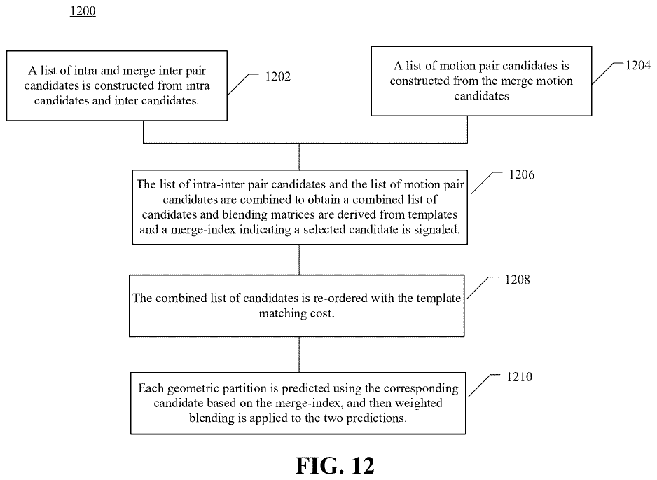

In some embodiments, whether to apply the intra and inter prediction mode to implicit GPM is determined an implicit mode. FIG. 12 is a flowchart of another exemplary method 1200 for implicit GPM with intra and inter prediction, according to some embodiments of the present disclosure. Method 1200 can be performed by an encoder (e.g., by process 200A of FIG. 2A or 200B of FIG. 2B), a decoder (e.g., by process 300A of FIG. 3A or 300B of FIG. 3B) or performed by one or more software or hardware components of an apparatus (e.g., apparatus 400 of FIG. 4). For example, a processor (e.g., processor 402 of FIG. 4) can perform method 1200. In some embodiments, method 1200 can be implemented by a computer program product, embodied in a computer-readable medium, including computer-executable instructions, such as program code, executed by computers (e.g., apparatus 400 of FIG. 4). Referring to FIG. 12, method 1200 may include the following steps 1202 to 1210.

When the implicit GPM mode is applied, step 1202 is performed. At step 1202, a list of intra and merge inter pair candidates is constructed from intra candidates and inter candidates. In some embodiments, the intra candidates are derived by the most probable modes (MPM) list and the inter motion vector candidates are derived from merge motion vector list. The intra modes in the MPM list are derived from the adjacent blocks, decoder-side intra mode derivation (DIMD), non-adjacent blocks and default intra prediction modes, sequentially. The first n intra modes in the MPM list are chosen, n is a number smaller than 22. Then the list of intra and merge inter pair candidates is constructed from the intra candidates and inter candidates. In the list of intra and merge inter pair candidates, a pair candidate can include an intra candidate for the first partition and an inter candidate the second partition; or an inter candidate for the first partition and an inter candidate for the second partition.

At step 1204, a list of motion pair candidates is constructed from the merge motion vector candidates.

At step 1206, the list of intra and merge inter pair candidates and the list of motion pair candidates are combined to obtain a combined list of candidates and blending matrices are derived from templates and a merge-index indicating a selected candidate is signaled. The selected candidate is from the combined list of candidates and is used for prediction. The two integer blending matrices (W0 and W1) are derived from the template (e.g. line above, 1 column left). The blending matrices are modelled as an affine linear function of the sample positions (x,y) in the current CU:

$$W 0 ( x , y ) = a . x + b . y + c \qquad ( 16 )$$

$$W 1 ( x , y ) = 1 - W 0 ( x , y ) \qquad ( 17 )$$

The parameters (a,b,c) are derived from the reference template using the same solver (MSE minimization) as the one used for CCCM, GLM or GL-CCCM.

At step 1208, the combined list of candidates is re-ordered with the template matching cost.

At step 1210, each geometric partition is predicted using the corresponding candidate based on the merge-index, and then weighted blending is applied to the two predictions. In some embodiments, for inter prediction partition, overlapped block motion compensation (OBMC) and luma mapping with chroma scaling (LMCS) are performed after motion compensation. When the used pair candidate is an intra and inter merge pair candidate, the final predicted sample is generated by weighting inter predicted samples and intra predicted samples with W0 and W1 matrices.

Embodiments of the present disclosure further provide method for applying template matching (TM) to the above-described implicit GPM with intra and inter prediction.

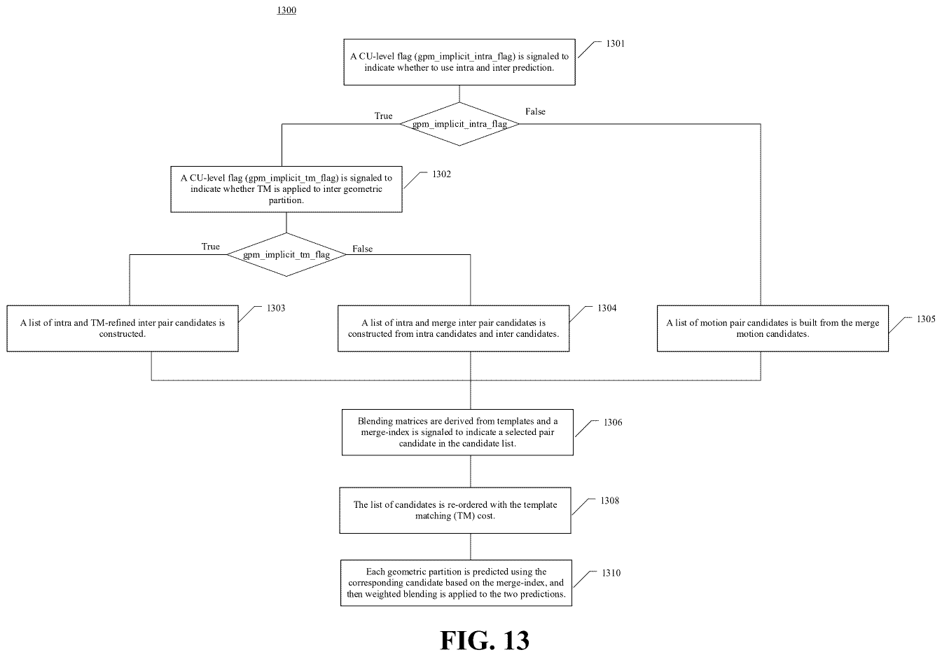

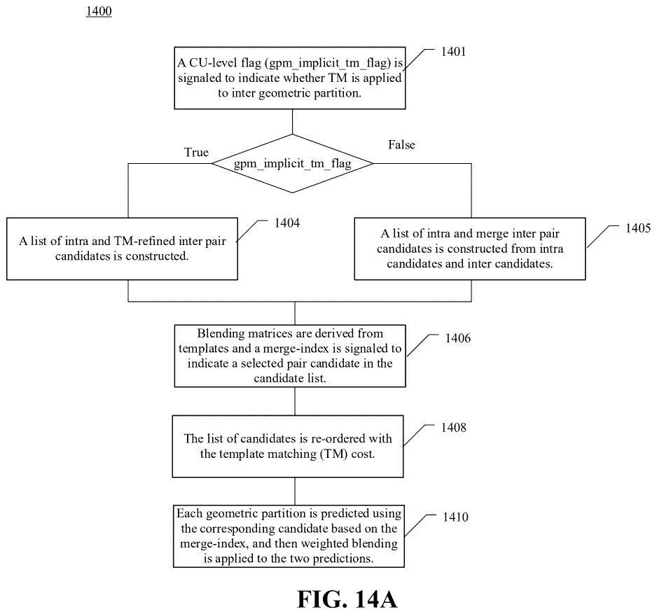

In some embodiments, whether to apply the TM extension to implicit GPM with intra and inter prediction is determined in an explicit method, and the template used to refine the inter candidates (e.g., motion vectors) includes both above and left neighboring samples. FIG. 13 is a flowchart of an exemplary method 1300 for applying template matching (TM) to implicit GPM, according to some embodiments of the present disclosure. Method 1300 can be performed by an encoder (e.g., by process 200A of FIG. 2A or 200B of FIG. 2B), a decoder (e.g., by process 300A of FIG. 3A or 300B of FIG. 3B) or performed by one or more software or hardware components of an apparatus (e.g., apparatus 400 of FIG. 4). For example, a processor (e.g., processor 402 of FIG. 4) can perform method 1300. In some embodiments, method 1300 can be implemented by a computer program product, embodied in a computer-readable medium, including computer-executable instructions, such as program code, executed by computers (e.g., apparatus 400 of FIG. 4). Referring to FIG. 13, method 1300 may include the following steps 1301 to 1310.

At step 1301, a CU-level flag (gpm_implicit_intra_flag) is signaled to indicate whether to use an intra and inter prediction. When the flag (i.e., gpm_implicit_intra_flag) is true, i.e., a value of the flag is equal to a first value, for example “1,” the intra and inter prediction is applied to the implicit GPM. When the flag (i.e., gpm_implicit_intra_flag) is false, i.e., a value of the flag is equal to a second value, for example “0,” the intra and inter prediction is not applied to the implicit GPM.

When the flag (i.e., gpm_implicit_intra_flag) is true, that is, the intra and inter prediction is applied to the implicit GPM, step 1302 is performed. At step 1302, a CU-level flag (gpm_implicit_tm_flag) is signaled to indicate whether TM is applied to inter geometric partition.

When the flag (i.e., gpm_implicit_tm_flag) is true, that is, TM is applied to inter geometric partition, step 1303 is performed. At step 1303, a list of intra and TM-refined inter pair candidates is constructed. The inter candidates (e.g., merge motion vectors) are refined using the TM. In some embodiment, the inter candidates are refined by minimizing the difference between the current template and the template in the reference picture using the same search pattern of merge mode with half-pel interpolation filter disabled. Then an intra and TM-refined inter pair list is constructed from the intra candidates and TM-refined motion vector candidates.

When the flag (i.e., gpm_implicit_tm_flag) is false, that is, whether TM is not applied to inter geometric partition, step 1304 is performed. Step 1304 is the same as step 1104 in method 1100 with reference to FIG. 11, which will not be repeated herein.

When the flag (i.e., gpm_implicit_intra_flag) is false, that is, intra and inter prediction is not applied to the implicit GPM, step 1305 is performed. Step 1305 is the same as step 1105 in method 1100 with reference to FIG. 11, which will not be repeated herein.

The subsequent steps (e.g. steps 1306 to 1310) are the same as steps 1106 to 1110 in method 1100 with reference to FIG. 11, which will not be repeated herein.

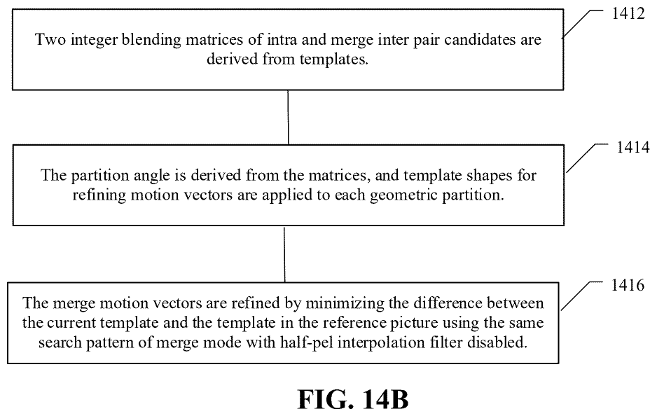

In some embodiments, whether to apply the TM extension to implicit GPM with intra and inter prediction is determined in an explicit method, and the template used to refine motion vectors includes only above neighboring samples, or only left neighboring samples, or both above and left neighboring samples. FIG. 14A is a flowchart of another exemplary method 1400 for applying template matching (TM) to implicit GPM, according to some embodiments of the present disclosure. Method 1400 can be performed by an encoder (e.g., by process 200A of FIG. 2A or 200B of FIG. 2B), a decoder (e.g., by process 300A of FIG. 3A or 300B of FIG. 3B) or performed by one or more software or hardware components of an apparatus (e.g., apparatus 400 of FIG. 4). For example, a processor (e.g., processor 402 of FIG. 4) can perform method 1400. In some embodiments, method 1400 can be implemented by a computer program product, embodied in a computer-readable medium, including computer-executable instructions, such as program code, executed by computers (e.g., apparatus 400 of FIG. 4). Referring to FIG. 14A, method 1400 may include the following steps 1401 to 1410.

When the implicit GPM with intra and inter prediction is applied, step 1402 is performed. In some embodiments, implicit GPM with intra and inter prediction is determined in an explicit mode or an implicit mode. At step 1401, a CU-level flag (gpm_implicit_tm_flag) is signaled to indicate whether TM is applied to inter geometric partition.

When the flag (i.e., gpm_implicit_tm_flag) is true, that is, TM is applied to inter geometric partition, step 1402 is performed. At step 1402, a list of intra and TM-refined inter pair candidates is constructed. Step 1402 further includes steps 1412 to 1416. FIG. 14B is a flowchart of sub-steps of method 1400, according to some embodiments of the present disclosure.

At step 1412, the two integer blending matrices of intra and merge inter pair candidates are derived from the templates (e.g. 1 line above, 1 column left).

At step 1414, the partition angle is derived from the matrices, and template shapes (e.g., above, left, or above and left) for refining the inter candidates (e.g., merge motion vectors) are applied to each geometric partition according to the mapping relationship in Table 2.

At step 1416, the inter candidates (e.g., merge motion vectors) are refined using TM, for example, by minimizing the difference between the current template and the template in the reference picture using the same search pattern of merge mode with half-pel interpolation filter disabled. Therefore, a list of intra and TM-refined inter pair candidates is constructed from the intra candidates and TM-refined motion vector candidates.

When the flag (i.e., gpm_implicit_tm_flag) is false, that is, TM is applied to inter geometric partition, step 1405 is performed. Step 1405 is the same as step 1104 in method 1100 with reference to FIG. 11, which will not be repeated herein.

The subsequent steps (e.g. steps 1406 to 1410) are the same as steps 1106 to 1110 in method 1100 with reference to FIG. 11, which will not be repeated herein.

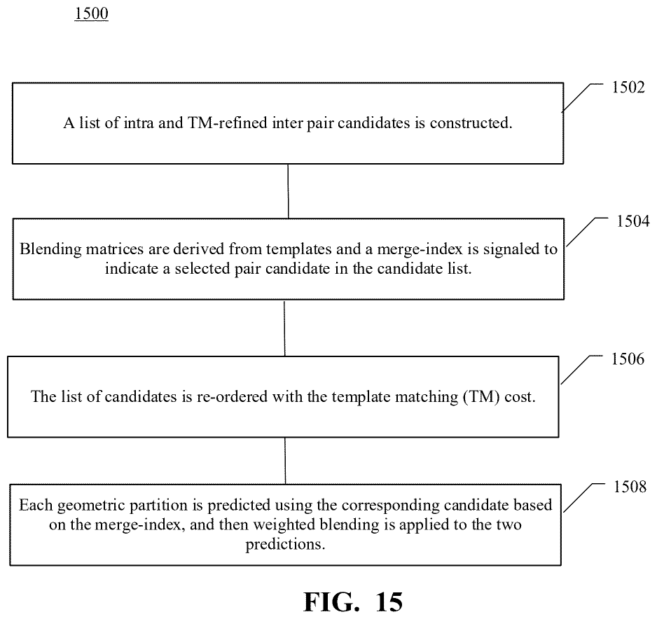

In some embodiments, the TM extension for implicit GPM with intra and inter prediction is always performed. FIG. 15 is a flow chart of another exemplary method 1500 for applying template matching (TM) to implicit GPM, according to some embodiments of the present disclosure. Method 1500 can be performed by an encoder (e.g., by process 200A of FIG. 2A or 200B of FIG. 2B), a decoder (e.g., by process 300A of FIG. 3A or 300B of FIG. 3B) or performed by one or more software or hardware components of an apparatus (e.g., apparatus 400 of FIG. 4). For example, a processor (e.g., processor 402 of FIG. 4) can perform method 1500. In some embodiments, method 1500 can be implemented by a computer program product, embodied in a computer-readable medium, including computer-executable instructions, such as program code, executed by computers (e.g., apparatus 400 of FIG. 4). Referring to FIG. 15, method 1500 may include the following steps 1502 to 1508.

At step 1502, when implicit GPM with intra and inter prediction is applied, a list of intra and TM-refined inter pair candidates is constructed. A template is constructed using left and above neighboring samples. The inter candidates (e.g., merge motion vectors) are always refined using TM, for example, by minimizing the difference between the current template and the template in the reference picture using the same search pattern of merge mode with half-pel interpolation filter disabled. Then the list of intra and TM-refined inter pair candidates is constructed from the intra candidates and TM processed inter candidates.

The subsequent steps (e.g. steps 1504 to 1508) are the same as steps 1106 to 1110 in method 1100 with reference to FIG. 11, which will not be repeated herein.

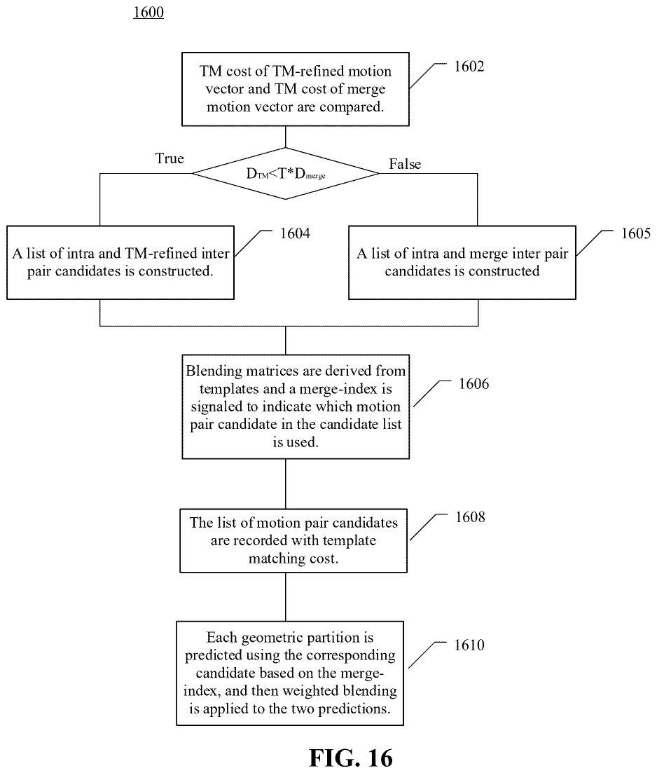

In some embodiments, whether to apply the TM extension to implicit GPM with intra and inter prediction is determined in an implicit method, and TM-refinement is performed according to template matching cost. FIG. 16 is a flowchart of another exemplary method 1600 for applying template matching (TM) to implicit GPM, according to some embodiments of the present disclosure. Method 1600 can be performed by an encoder (e.g., by process 200A of FIG. 2A or 200B of FIG. 2B), a decoder (e.g., by process 300A of FIG. 3A or 300B of FIG. 3B) or performed by one or more software or hardware components of an apparatus (e.g., apparatus 400 of FIG. 4). For example, a processor (e.g., processor 402 of FIG. 4) can perform method 1600. In some embodiments, method 1600 can be implemented by a computer program product, embodied in a computer-readable medium, including computer-executable instructions, such as program code, executed by computers (e.g., apparatus 400 of FIG. 4). Referring to FIG. 16, method 1600 may include the following steps 1602 to 1610.

When implicit GPM with intra and inter prediction is applied, a template is constructed using left and above neighboring samples. In order to ensure that the motion vector refined by TM is better than merge motion vector, a determination of using motion vector refined by TM or using merge motion vector is performed.

At step 1602, TM cost of TM-refined motion vector (i.e., TM-refined inter candidate) and TM cost of merge motion vector (i.e., merge inter candidate) are compared. In some embodiments, a threshold factor is set. TM cost of TM-refined motion vector is compared with the TM cost of merge motion vector multiplied by the threshold factor, and the condition of motion vector refined by TM as follows:

$$M {V}_{p r o c e s s e d} = \{ \begin{matrix}{MV}_{TM} , & {D}_{T M} < T * {D}_{m e r g e} \\ {MV}_{m e r g e} , & otherwise\end{matrix} \qquad ( 18 )$$

where MV_{processed}, MV_{TM}, MV_{merge} are motion vector of processed, TM-refined, and merge, respectively. D_{TM} and D_{merge} are the TM cost of TM-refined motion vector and merge motion vector. T is the threshold factor. In some embodiments, the threshold factor is set to be smaller than 1, for example, the threshold factor is set as 0.9.

At step 1604, when a ratio of the TM cost of TM-refined motion vector to the TM cost of merge motion vector is less than a threshold, a list of intra and TM-refined inter pair candidates is constructed. The refined motion vector is used in the motion compensation.

At step 1605, when a ratio of the TM cost of TM-refined motion vector to the TM cost of merge motion vector is not less than a threshold, the original merge motion vector is used in the motion compensation, i.e., a list of intra and merge inter pair candidates is constructed.

The subsequent steps (e.g. steps 1606 to 1610) are the same as steps 1106 to 1110 in method 1100 with reference to FIG. 11, which will not be repeated herein.

Embodiments of the present disclosure further provide methods for applying merge motion vector differences (MMVD) to the above-described implicit GPM with intra and inter prediction.

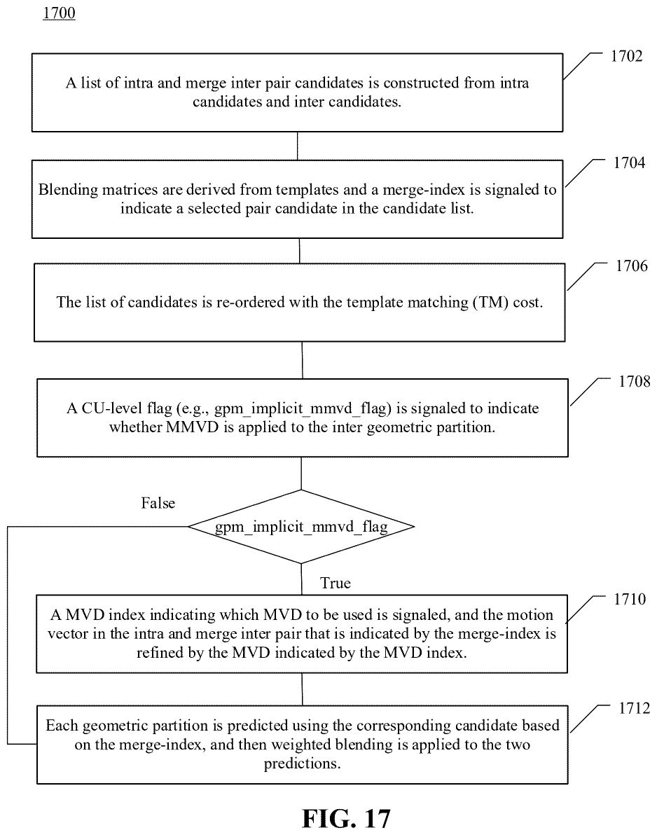

In some embodiments, whether to apply the MMVD extension to implicit GPM with intra and inter prediction determined in an explicit method. FIG. 17 is a flowchart of an exemplary method 1700 for applying merge motion vector differences (MMVD) to implicit GPM, according to some embodiments of the present disclosure. Method 1700 can be performed by an encoder (e.g., by process 200A of FIG. 2A or 200B of FIG. 2B), a decoder (e.g., by process 300A of FIG. 3A or 300B of FIG. 3B) or performed by one or more software or hardware components of an apparatus (e.g., apparatus 400 of FIG. 4). For example, a processor (e.g., processor 402 of FIG. 4) can perform method 1700. In some embodiments, method 1700 can be implemented by a computer program product, embodied in a computer-readable medium, including computer-executable instructions, such as program code, executed by computers (e.g., apparatus 400 of FIG. 4). Referring to FIG. 17, method 1700 may include the following steps 1702 to 1712.

When the implicit GPM with intra and inter prediction mode is applied, steps 1702 to 1706 are performed. Steps 1702 to 1706 are the same as steps 1104 to 1108 in method 1100 with reference to FIG. 11, which will not be repeated herein.

At step 1708, a CU-level flag (e.g., gpm_implicit_mmvd_flag) is signaled to indicate whether MMVD is applied to the inter geometric partition. The flag (i.e., gpm_implicit_mmvd_flag) being true indicates that MMVD is applied to the inter geometric partition. The flag (i.e., gpm_implicit_mmvd_flag) being false indicates that MMVD is not applied to the inter geometric partition.

At step 1710, when the flag (i.e., gpm_implicit_mmvd_flag) is true, a MVD index (e.g., gpm_implicit_mmvd_idx) indicating which MVD to be used is signaled, and the motion vector in the intra and merge inter pair that is indicated by the merge-index is refined by the MVD indicated by the MVD index. And then step 1712 is performed.

When the flag (i.e., gpm_implicit_mmvd_flag) is false, the motion vector is not refined by MVD, i.e., step 1710 is skipped, and step 1712 is performed.

Step 1712 is the same as step 1110 described above with reference to FIG. 11, which will not be repeated herein.

Embodiments of the present disclosure further provide methods for applying both template matching (TM) and merge motion vector differences (MMVD) to implicit GPM with intra and inter prediction.

In some embodiments, the TM extension and MMVD extension are both in explicit modes. The order for determining whether to apply TM extension and MMVD extension can be different. TM extension and MMVD extension cannot be performed to the implicit GPM with intra or inter prediction at the same time. In some embodiments, the flag indicating whether the TM extension is applied is signaled before the flag indicating whether the MMVD extension is applied. For example, when gpm_implicit_intra_flag is true, the gpm_implicit_tm_flag is signaled. When gpm_implicit_tm_flag is true, the gpm_implicit_mmvd_flag is not signaled. When gpm_implicit_tm_flag is false, the gpm_implicit_mmvd_flag is signaled. When gpm_implicit_intra_flag is not signaled, both gpm_implicit_tm_flag and gpm_implicit_mmvd_flag are not signaled.

In some embodiments, the flag indicating whether the MMVD extension is applied is signaled before the flag indicating whether the TM extension is applied. When gpm_implicit_intra_flag is true, the gpm_implicit_mmvd_flag is signaled. When gpm_implicit_mmvd_flag is true, the gpm_implicit_tm_flag is not signaled. When gpm_implicit_mmvd_flag is false, the gpm_implicit_tm_flag is signaled. When gpm_implicit_intra_flag is not signaled, both two flags are not signaled.

In some embodiments, the TM extension is in an implicit mode and the MMVD extension is in an explicit mode. For example, when gpm_implicit_intra_flag is true, the gpm_implicit_mmvd_flag is signaled. When gpm_implicit_intra_flag is false, the gpm_implicit_mmvd_flag is not signaled.

It can be understood that methods described above (including methods 1000 to 1700) can be performed by a decoder by decoding the flags and indices from a bitstream,

The embodiments described in the present disclosure can be freely combined.

In some embodiments, a non-transitory computer readable medium storing a bitstream is provided. The bitstream is generated by receiving a video sequence and encoding the video sequence to generate coded information included in the bitstream. The bitstream can be transmitted to a decoder for decoding. The video sequence is encoded by the above-described methods.

In some embodiments, a non-transitory computer-readable storage medium including instructions is also provided, and the instructions may be executed by a device (such as the disclosed encoder and decoder), for performing the above-described methods. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM or any other flash memory, NVRAM, a cache, a register, any other memory chip or cartridge, and networked versions of the same. The device may include one or more processors (CPUs), an input/output interface, a network interface, and/or a memory.

It should be noted that, the relational terms herein such as “first” and “second” are used only to differentiate an entity or operation from another entity or operation, and do not require or imply any actual relationship or sequence between these entities or operations. Moreover, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items.

As used herein, unless specifically stated otherwise, the term “or” encompasses all possible combinations, except where infeasible. For example, if it is stated that a database may include A or B, then, unless specifically stated otherwise or infeasible, the database may include A, or B, or A and B. As a second example, if it is stated that a database may include A, B, or C, then, unless specifically stated otherwise or infeasible, the database may include A, or B, or C, or A and B, or A and C, or B and C, or A and B and C.

It is appreciated that the above-described embodiments can be implemented by hardware, or software (program codes), or a combination of hardware and software. If implemented by software, it may be stored in the above-described computer-readable media. The software, when executed by the processor can perform the disclosed methods. The computing units and other functional units described in this disclosure can be implemented by hardware, or software, or a combination of hardware and software. One of ordinary skill in the art will also understand that multiple ones of the above-described modules/units may be combined as one module/unit, and each of the above-described modules/units may be further divided into a plurality of sub-modules/sub-units.

The embodiments may further be described using the following clauses:

1. A method for encoding a video sequence coded using implicit geometric partition mode (GPM), the method comprising:
receiving a video sequence; and
encoding the video sequence by:
   determining that an implicit geometric partitioning mode (GPM) is applied to a coding block, a coding block being split into two geometric partitions; and
   performing an intra and inter prediction on the coding block.

2. The method according to clause 1, wherein performing the intra and inter prediction on the coding block further comprises:
constructing a list of intra and inter pair candidates from intra candidates and inter candidates, wherein the intra candidates are derived from a most probable modes (MPM) list;
   and the inter candidates are derived from a merge motion vector list;
deriving, based on the list of intra and inter pair candidates, two blending matrices associated with the coding block;
determining a pair candidate for predicting the coding block;
predicting the two geometric partitions with the determined pair candidate; and
generating a final predicted coding unit by weighting the predicted two geometric partitions with the two blending matrices.

3. The method according to clause 2, wherein determining the pair candidate for predicting the coding block further comprises:
performing motion compensation on the inter candidates; and
performing overlapped block motion compensation (OBMC) and luma mapping with chroma scaling (LMCS) after the motion compensation.

4. The method according to clause 2, wherein determining the pair candidate for predicting the coding block further comprises:
encoding an index indicating the pair candidate for predicting the coding block.

5. The method according to clause 2, wherein the list of intra and inter pair candidates is reordered based on template matching (TM) cost.

6. The method according to clause 2, wherein before performing intra and inter prediction on the coding block:
encoding a flag indicating whether the intra and inter prediction is enabled; and
in response to the flag indicating the intra and inter prediction being enabled, performing the intra and inter prediction on the coding block.

7. The method according to clause 1, wherein performing the intra and inter prediction on the coding block comprises:
constructing a list of intra and inter pair candidates from intra candidates and inter candidates;
constructing a list of motion pair candidates from merge candidates;
combining the list of intra and inter pair candidates and the list of motion pair candidates to obtain a combined list of pair candidates;
deriving, based on the list of intra and inter pair candidates, two blending matrices associated with the coding block;
determining a pair candidate from the combined list of pair candidates for predicting the coding block;
predicting the two geometric partitions with the determined pair candidate; and
when the determined pair candidate is an intra and inter pair candidate, generating a final predicted coding unit by weighting the predicted two geometric partitions with the two blending matrices.

8. The method according to clause 7, wherein the intra candidates are derived from a most probable modes (MPM) list; and the inter candidates are derived from a merge motion vector list.

9. The method according to clause 2, wherein before performing intra and inter prediction on the coding block further comprises:
encoding a first flag indicating whether the intra and inter prediction is enabled; and
in response to the first flag indicating the intra and inter prediction is enabled, performing the intra and inter prediction on the coding block, wherein performing the intra and inter prediction further comprises:
   encoding a second flag indicating whether template matching (TM) is enabled; and
   in response to the second flag indicating the TM is enabled, refining the inter candidates using the TM, wherein the list of intra and inter pair candidates is a list of intra and TM-refined inter pair candidates.

10. The method according to clause 9, wherein a template used to refine the inter candidate comprises both above neighboring samples and left neighboring samples.

11. The method according to clause 9, wherein refining the inter candidates use the TM further comprises:
deriving, two integer blending matrices of intra and merge inter pair candidates from a template, wherein the template comprises above neighboring samples, left neighboring samples, or both the above neighboring samples and the left neighboring samples;
deriving a partition angle from the two integer blending matrices;
applying a template shape of the template to each partition; and
refining the inter candidates using the TM.

12. The method according to clause 2, wherein performing the intra and inter prediction on the coding block further comprises:
refining the inter candidates using template matching, wherein the list of intra and inter pair candidates is a list of intra and TM-refined inter pair candidates and a template used to refine the inter candidate comprises both above neighboring samples and left neighboring samples.

13. The method according to clause 2, wherein the list of intra and inter pair candidates is a list of intra and merge inter pair candidates, and performing the intra and inter prediction on the coding block further comprises:
refining the inter candidates using template matching (TM) to obtain a list of intra and TM-refined inter pair candidates;
comparing a first TM cost of the TM-refined inter candidate and a second TM cost of merge inter candidate;
in response to a ratio of the first TM cost to the second TM cost is less than a threshold, performing the intra and inter prediction using the list of intra and TM-refined inter pair candidates; and
in response to the ratio of the first TM cost to the second TM cost is not less than the threshold, performing the intra and inter prediction using the list of intra and merge inter pair candidates.

14. The method according to clause 2, wherein after determining the pair candidate for predicting the coding block, the performing the intra and inter prediction on the coding block further comprises:
encoding a flag indicating whether merge motion vector differences (MMVD) is enabled; and
in response to the flag indicating the MMVD being enabled, refining an inter candidate of the determined pair candidate using the MMVD.

15. The method according to clause 14, wherein refining the inter candidate of the determined pair candidate using the MMVD further comprises:
encoding an index indicating a motion vector difference (MVD) to be used; and
refining the inter candidate by the MVD.

16. The method according to clause 6, wherein performing the intra and inter prediction on the coding block further comprises:
refining the inter candidates using template marching (TM); or
refining an inter candidate of the determined pair candidate using merge motion vector differences (MMVD).

17. The method according to clause 16, wherein performing the intra and inter prediction on the coding block further comprises:
encoding a first flag indicating whether the TM is enabled; and
in response to the flag indicating the TM being enabled, encoding a second flag indicating whether the MMVD is enabled.

18. The method according to clause 16, wherein performing the intra and inter prediction on the coding block further comprises:
encoding a first flag indicating whether the MMVD is enabled.

19. The method according to clause 18, wherein performing the intra and inter prediction on the coding block further comprises:
in response to the first flag indicating the MMVD being enabled, encoding a second flag indicating whether the TM is enabled.

20. A method for decoding a bitstream, the method comprising:
receiving a bitstream; and
decoding the bitstream to output a video sequence, the decoding comprising:
   determining that an implicit geometric partitioning mode (GPM) is applied to a coding block, a coding block being split into two geometric partitions; and
   performing an intra and inter prediction on the coding block.

21. The method according to clause 20, wherein performing the intra and inter prediction on the coding block further comprises:
constructing a list of intra and inter pair candidates from intra candidates and inter candidates, wherein the intra candidates are derived from a most probable modes (MPM) list;
   and the inter candidates are derived from a merge motion vector list;
deriving, based on the list of intra and inter pair candidates, two blending matrices associated with the coding block;
determining a pair candidate for predicting the coding block;
predicting the two geometric partitions with the determined pair candidate; and
generating a final predicted coding unit by weighting the predicted two geometric partitions with the two blending matrices.

22. The method according to clause 21, wherein determining the pair candidate for predicting the coding block further comprises:
performing motion compensation on the inter candidates; and
performing overlapped block motion compensation (OBMC) and luma mapping with chroma scaling (LMCS) after the motion compensation.

23. The method according to clause 21, wherein determining the pair candidate for predicting the coding block further comprises:
decoding an index indicating the pair candidate for predicting the coding block.

24. The method according to clause 21, wherein the list of intra and inter pair candidates is reordered based on template matching (TM) cost.

25. The method according to clause 21, wherein before performing intra and inter prediction on the coding block:
decoding a flag indicating whether the intra and inter prediction is enabled; and
in response to the flag indicating the intra and inter prediction being enabled, performing the intra and inter prediction on the coding block.

26. The method according to clause 20, wherein performing the intra and inter prediction on the coding block comprises:
constructing a list of intra and inter pair candidates from intra candidates and inter candidates;
constructing a list of motion pair candidates from merge candidates;
combining the list of intra and inter pair candidates and the list of motion pair candidates to obtain a combined list of pair candidates;
deriving, based on the list of intra and inter pair candidates, two blending matrices associated with the coding block;
determining a pair candidate from the combined list of pair candidates for predicting the coding block;
predicting the two geometric partitions with the determined pair candidate; and
when the determined pair candidate is an intra and inter pair candidate, generating a final predicted coding unit by weighting the predicted two geometric partitions with the two blending matrices.

27. The method according to clause 26, wherein the intra candidates are derived from a most probable modes (MPM) list; and the inter candidates are derived from a merge motion vector list.

28. The method according to clause 21, wherein before performing intra and inter prediction on the coding block further comprises:
decoding a first flag indicating whether the intra and inter prediction is enabled; and
in response to the first flag indicating the intra and inter prediction is enabled, performing the intra and inter prediction on the coding block, wherein performing the intra and inter prediction further comprises:
   decoding a second flag indicating whether template matching (TM) is enabled; and
   in response to the second flag indicating the TM is enabled, refining the inter candidates using the TM, wherein the list of intra and inter pair candidates is a list of intra and TM-refined inter pair candidates.

29. The method according to clause 28, wherein a template used to refine the inter candidate comprises both above neighboring samples and left neighboring samples.

30. The method according to clause 28, wherein refining the inter candidates use the TM further comprises:
deriving, two integer blending matrices of intra and merge inter pair candidates from a template, wherein the template comprises above neighboring samples, left neighboring samples, or both the above neighboring samples and the left neighboring samples;
deriving a partition angle from the two integer blending matrices;
applying a template shape of the template to each partition; and
refining the inter candidates using the TM.

31. The method according to clause 21, wherein performing the intra and inter prediction on the coding block further comprises:
refining the inter candidates using template matching, wherein the list of intra and inter pair candidates is a list of intra and TM-refined inter pair candidates and a template used to refine the inter candidate comprises both above neighboring samples and left neighboring samples.

32. The method according to clause 21, wherein the list of intra and inter pair candidates is a list of intra and merge inter pair candidates, and performing the intra and inter prediction on the coding block further comprises:
refining the inter candidates using template matching (TM) to obtain a list of intra and TM-refined inter pair candidates;
comparing a first TM cost of the TM-refined inter candidate and a second TM cost of merge inter candidate;
in response to a ratio of the first TM cost to the second TM cost is less than a threshold, performing the intra and inter prediction using the list of intra and TM-refined inter pair candidates; and
in response to the ratio of the first TM cost to the second TM cost is not less than the threshold, performing the intra and inter prediction using the list of intra and merge inter pair candidates.

33. The method according to clause 21, wherein after determining the pair candidate for predicting the coding block, the performing the intra and inter prediction on the coding block further comprises:
decoding a flag indicating whether merge motion vector differences (MMVD) is enabled; and
in response to the flag indicating the MMVD being enabled, refining an inter candidate of the determined pair candidate using the MMVD.

34. The method according to clause 33, wherein refining the inter candidate of the determined pair candidate using the MMVD further comprises:
decoding an index indicating a motion vector difference (MVD) to be used; and
refining the inter candidate by the MVD.

35. The method according to clause 25, wherein performing the intra and inter prediction on the coding block further comprises:
refining the inter candidates using template marching (TM); or
refining an inter candidate of the determined pair candidate using merge motion vector differences (MMVD).

36. The method according to clause 35, wherein performing the intra and inter prediction on the coding block further comprises:
decoding a first flag indicating whether the TM is enabled; and
in response to the flag indicating the TM being enabled, decoding a second flag indicating whether the MMVD is enabled.

37. The method according to clause 35, wherein performing the intra and inter prediction on the coding block further comprises:
decoding a first flag indicating whether the MMVD is enabled.

38. The method according to clause 37, wherein performing the intra and inter prediction on the coding block further comprises:
in response to the first flag indicating the MMVD being enabled, decoding a second flag indicating whether the TM is enabled.

39. A method for signaling a bitstream, the method comprising:
receiving a video sequence;
encoding the video sequence by:
   determining that an implicit geometric partitioning mode (GPM) is applied to a coding block, a coding block being split into two geometric partitions; and
   performing an intra and inter prediction on the coding block; and
signaling a bitstream that is generated based on the encoding.

40. The method according to clause 39, wherein performing the intra and inter prediction on the coding block further comprises:
constructing a list of intra and inter pair candidates from intra candidates and inter candidates, wherein the intra candidates are derived from a most probable modes (MPM) list;
   and the inter candidates are derived from a merge motion vector list;
deriving, based on the list of intra and inter pair candidates, two blending matrices associated with the coding block;
determining a pair candidate for predicting the coding block;
predicting the two geometric partitions with the determined pair candidate; and
generating a final predicted coding unit by weighting the predicted two geometric partitions with the two blending matrices.

41. The method according to clause 40, wherein determining the pair candidate for predicting the coding block further comprises:
performing motion compensation on the inter candidates; and
performing overlapped block motion compensation (OBMC) and luma mapping with chroma scaling (LMCS) after the motion compensation.

42. The method according to clause 40, wherein determining the pair candidate for predicting the coding block further comprises:
encoding an index indicating the pair candidate for predicting the coding block.

43. The method according to clause 40, wherein the list of intra and inter pair candidates is reordered based on template matching (TM) cost.

44. The method according to clause 40, wherein before performing intra and inter prediction on the coding block:
encoding a flag indicating whether the intra and inter prediction is enabled; and
in response to the flag indicating the intra and inter prediction being enabled, performing the intra and inter prediction on the coding block.

45. The method according to clause 39, wherein performing the intra and inter prediction on the coding block comprises:
constructing a list of intra and inter pair candidates from intra candidates and inter candidates;
constructing a list of motion pair candidates from merge candidates;
combining the list of intra and inter pair candidates and the list of motion pair candidates to obtain a combined list of pair candidates;
deriving, based on the list of intra and inter pair candidates, two blending matrices associated with the coding block;
determining a pair candidate from the combined list of pair candidates for predicting the coding block;
predicting the two geometric partitions with the determined pair candidate; and
when the determined pair candidate is an intra and inter pair candidate, generating a final predicted coding unit by weighting the predicted two geometric partitions with the two blending matrices.

46. The method according to clause 45, wherein the intra candidates are derived from a most probable modes (MPM) list; and the inter candidates are derived from a merge motion vector list.

47. The method according to clause 40, wherein before performing intra and inter prediction on the coding block further comprises:
encoding a first flag indicating whether the intra and inter prediction is enabled; and
in response to the first flag indicating the intra and inter prediction is enabled, performing the intra and inter prediction on the coding block, wherein performing the intra and inter prediction further comprises:
   encoding a second flag indicating whether template matching (TM) is enabled; and
   in response to the second flag indicating the TM is enabled, refining the inter candidates using the TM, wherein the list of intra and inter pair candidates is a list of intra and TM-refined inter pair candidates.

48. The method according to clause 47, wherein a template used to refine the inter candidate comprises both above neighboring samples and left neighboring samples.

49. The method according to clause 47, wherein refining the inter candidates use the TM further comprises:
deriving, two integer blending matrices of intra and merge inter pair candidates from a template, wherein the template comprises above neighboring samples, left neighboring samples, or both the above neighboring samples and the left neighboring samples;
deriving a partition angle from the two integer blending matrices;
applying a template shape of the template to each partition; and
refining the inter candidates using the TM.

50. The method according to clause 40, wherein performing the intra and inter prediction on the coding block further comprises:
refining the inter candidates using template matching, wherein the list of intra and inter pair candidates is a list of intra and TM-refined inter pair candidates and a template used to refine the inter candidate comprises both above neighboring samples and left neighboring samples.

51. The method according to clause 40, wherein the list of intra and inter pair candidates is a list of intra and merge inter pair candidates, and performing the intra and inter prediction on the coding block further comprises:
refining the inter candidates using template matching (TM) to obtain a list of intra and TM-refined inter pair candidates;
comparing a first TM cost of the TM-refined inter candidate and a second TM cost of merge inter candidate;
in response to a ratio of the first TM cost to the second TM cost is less than a threshold, performing the intra and inter prediction using the list of intra and TM-refined inter pair candidates; and
in response to the ratio of the first TM cost to the second TM cost is not less than the threshold, performing the intra and inter prediction using the list of intra and merge inter pair candidates.

52. The method according to clause 40, wherein after determining the pair candidate for predicting the coding block, the performing the intra and inter prediction on the coding block further comprises:
encoding a flag indicating whether merge motion vector differences (MMVD) is enabled; and
in response to the flag indicating the MMVD being enabled, refining an inter candidate of the determined pair candidate using the MMVD.

53. The method according to clause 52, wherein refining the inter candidate of the determined pair candidate using the MMVD further comprises:
encoding an index indicating a motion vector difference (MVD) to be used; and
refining the inter candidate by the MVD.

54. The method according to clause 44, wherein performing the intra and inter prediction on the coding block further comprises:
refining the inter candidates using template marching (TM); or
refining an inter candidate of the determined pair candidate using merge motion vector differences (MMVD).

55. The method according to clause 54, wherein performing the intra and inter prediction on the coding block further comprises:
encoding a first flag indicating whether the TM is enabled; and
in response to the flag indicating the TM being enabled, encoding a second flag indicating whether the MMVD is enabled.

56. The method according to clause 54, wherein performing the intra and inter prediction on the coding block further comprises:
encoding a first flag indicating whether the MMVD is enabled.

57. The method according to clause 56, wherein performing the intra and inter prediction on the coding block further comprises:
in response to the first flag indicating the MMVD being enabled, encoding a second flag indicating whether the TM is enabled.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the invention disclosed herein. It is intended that the specification and examples be considered as exemplary only, with a true scope and spirit of the invention being indicated by the following claims. It is also intended that the sequence of steps shown in figures are only for illustrative purposes and are not intended to be limited to any particular sequence of steps. As such, those skilled in the art can appreciate that these steps can be performed in a different order while implementing the same method.

In the drawings and specification, there have been disclosed exemplary embodiments. However, many variations and modifications can be made to these embodiments. Accordingly, although specific terms are employed, they are used in a generic and descriptive sense only and not for purposes of limitation.

What is claimed is:

1. A method for encoding a video sequence coded using implicit geometric partition mode (GPM), the method comprising:
receiving a video sequence; and
encoding the video sequence by:
determining that an implicit geometric partitioning mode (GPM) is applied to a coding block, a coding block being split into two geometric partitions; and
performing an intra and inter prediction on the coding block.

2. The method according to claim 1, wherein performing the intra and inter prediction on the coding block further comprises:
constructing a list of intra and inter pair candidates from intra candidates and inter candidates, wherein the intra candidates are derived from a most probable modes (MPM) list;
and the inter candidates are derived from a merge motion vector list;
deriving, based on the list of intra and inter pair candidates, two blending matrices associated with the coding block;
determining a pair candidate for predicting the coding block;
predicting the two geometric partitions with the determined pair candidate; and
generating a final predicted coding unit by weighting the predicted two geometric partitions with the two blending matrices.

3. The method according to claim 2, wherein determining the pair candidate for predicting the coding block further comprises:
performing motion compensation on the inter candidates; and
performing overlapped block motion compensation (OBMC) and luma mapping with chroma scaling (LMCS) after the motion compensation.

4. The method according to claim 2, wherein determining the pair candidate for predicting the coding block further comprises:
encoding an index indicating the pair candidate for predicting the coding block.

5. The method according to claim 2, wherein the list of intra and inter pair candidates is reordered based on template matching (TM) cost.

6. The method according to claim 2, wherein before performing intra and inter prediction on the coding block:
encoding a flag indicating whether the intra and inter prediction is enabled; and
in response to the flag indicating the intra and inter prediction being enabled, performing the intra and inter prediction on the coding block.

7. The method according to claim 6, wherein performing the intra and inter prediction on the coding block further comprises:
refining the inter candidates using template marching (TM); or
refining an inter candidate of the determined pair candidate using merge motion vector differences (MMVD).

8. A method for decoding a bitstream, the method comprising:
receiving a bitstream; and
decoding the bitstream to output a video sequence, the decoding comprising:
determining that an implicit geometric partitioning mode (GPM) is applied to a coding block, a coding block being split into two geometric partitions; and
performing an intra and inter prediction on the coding block.

9. The method according to claim 8, wherein performing the intra and inter prediction on the coding block further comprises:
constructing a list of intra and inter pair candidates from intra candidates and inter candidates, wherein the intra candidates are derived from a most probable modes (MPM) list;
and the inter candidates are derived from a merge motion vector list;
deriving, based on the list of intra and inter pair candidates, two blending matrices associated with the coding block;
determining a pair candidate for predicting the coding block;
predicting the two geometric partitions with the determined pair candidate; and
generating a final predicted coding unit by weighting the predicted two geometric partitions with the two blending matrices.

10. The method according to claim 9, wherein determining the pair candidate for predicting the coding block further comprises:
performing motion compensation on the inter candidates; and
performing overlapped block motion compensation (OBMC) and luma mapping with chroma scaling (LMCS) after the motion compensation.

11. The method according to claim 9, wherein determining the pair candidate for predicting the coding block further comprises:
decoding an index indicating the pair candidate for predicting the coding block.

12. The method according to claim 9, wherein the list of intra and inter pair candidates is reordered based on template matching (TM) cost.

13. The method according to claim 9, wherein before performing intra and inter prediction on the coding block:
decoding a flag indicating whether the intra and inter prediction is enabled; and
in response to the flag indicating the intra and inter prediction being enabled, performing the intra and inter prediction on the coding block.

14. The method according to claim 13, wherein performing the intra and inter prediction on the coding block further comprises:
refining the inter candidates using template marching (TM); or
refining an inter candidate of the determined pair candidate using merge motion vector differences (MMVD).

15. A method for signaling a bitstream, the method comprising:
receiving a video sequence;
encoding the video sequence by:
determining that an implicit geometric partitioning mode (GPM) is applied to a coding block, a coding block being split into two geometric partitions; and
performing an intra and inter prediction on the coding block; and
signaling a bitstream that is generated based on the encoding.

16. The method according to claim 15, wherein performing the intra and inter prediction on the coding block further comprises:
constructing a list of intra and inter pair candidates from intra candidates and inter candidates, wherein the intra candidates are derived from a most probable modes (MPM) list;
and the inter candidates are derived from a merge motion vector list;
deriving, based on the list of intra and inter pair candidates, two blending matrices associated with the coding block;
determining a pair candidate for predicting the coding block;
predicting the two geometric partitions with the determined pair candidate; and
generating a final predicted coding unit by weighting the predicted two geometric partitions with the two blending matrices.

17. The method according to claim 16, wherein determining the pair candidate for predicting the coding block further comprises:
performing motion compensation on the inter candidates; and
performing overlapped block motion compensation (OBMC) and luma mapping with chroma scaling (LMCS) after the motion compensation.

18. The method according to claim 16, wherein determining the pair candidate for predicting the coding block further comprises:
encoding an index indicating the pair candidate for predicting the coding block.

19. The method according to claim 16, wherein the list of intra and inter pair candidates is reordered based on template matching (TM) cost.

20. The method according to claim 16, wherein before performing intra and inter prediction on the coding block:
encoding a flag indicating whether the intra and inter prediction is enabled; and
in response to the flag indicating the intra and inter prediction being enabled, performing the intra and inter prediction on the coding block.
